(19) United States
(12) Patent Application Publication
(10) Pub. No.: US 2008/0184502 A1
(43) Pub. Date: Aug. 7, 2008

(54) HANDICAP RAMP FOR ACCESSING AND EGRESSING TRANSPORT VEHICLES

(76) Inventor: Thomas Edward Roberts, Bristol, IN (US)

Correspondence Address: SACHNOFF & WEAVER, LTD., 10 SOUTH WACKER DRIVE, CHICAGO, IL, 60606-7507, US

(21) Appl. No.: 12/027,568

(22) Filed: Feb. 7, 2008

Related U.S. Application Data
(60) Provisional application No. 60/888,717, filed on Feb. 7, 2007.

(51) Int. Cl. A61G 3/06

(52) U.S. Cl. 14/71.1; 14/69.5

(57) ABSTRACT

An expandable and contractable ramp assembly is provided for moving handicapped persons between a first elevation and a structure such as a transport vehicle or a stationary structure at a second elevation. The ramp assembly comprises an attachment assembly adapted to removably secure a first end of the ramp assembly to the vehicle or structure, the ramp assembly being expandable and contractable in a linear direction. The attachment assembly provides pivotal movement of the ramp assembly in an arcuate direction for storage of the ramp assembly when not in use. The ramp assembly comprises a pair of parallel disposed scissors assemblies, the scissors assemblies moveable between expanded and contracted positions. A light weight tread support assembly extends between and is operatively connected to the pair of parallel scissors assemblies, the tread support assembly including a plurality of tread plates connected to a tread plate support structure that supports the tread plates. In an embodiment, an expandable and contractable ramp assembly is adapted to be removably attached to and extendable from the rear of an ambulance deck, providing assistance in loading a patient-bearing ambulance stretcher into an ambulance, or removing the stretcher from an ambulance.

### PRIORITY

This application claims priority to provisional patent application Ser. No. 60/888,717 filed Feb. 8, 2007, to the extent allowed by law.

### FIELD OF THE INVENTION

The present invention relates to expandable and retractable loading ramps providing handicapped persons in movable chairs with access and egress to transport vehicles such as van-type automotive vehicles, railroad cars, boats and the like. Specifically, the present invention is an improvement over existing loading ramps by providing an expandable and contractable ramp structure that is light enough in weight to be manually installed and removed from a transport vehicle, yet constructed with sufficient strength to support the combination of a moveable handicap chair, the patient in the chair, and a person assisting the chair up or down the ramp. The ramp structure of the present invention also embodies sufficient structural strength to support a motorized wheelchair and handicapped person. In an embodiment, a form of the invention provides a ramp for easily loading and unloading a patient-bearing stretcher onto and from an ambulance or other emergency medical vehicle.

### BACKGROUND OF THE INVENTION

A significant percentage of the world's population, through health conditions, debilitating accident, age or other cause, has lost the mobility provided by their legs, and are confined to wheeled chairs and similar such mobile supports upon which such persons must rely to restore a modicum of mobility to their lives. More recently, society in general, and governmental agencies have recognized that our laws and infrastructure can be modified to remove barriers to mobility in the day-to-day life of wheelchair bound disabled people. The Americans with Disabilities Act (ADA) was enacted several years ago to compel building owners to provide access and egress to working and public environments, and to provide handicap accessible facilities in building structures, such as work stations or offices, washroom facilities, elevators and the like. In addition, ramps were provided on curbs so that wheelchairs could readily roll smoothly from sidewalk to street, and then onto the opposite sidewalk.

A need also exists to provide wheelchair bound patients with access into and egress from vehicles, such as vans and mini-type vans, railroad cars, boats and the like. Many such automotive vans today, for example, have an area set aside inside the van where a wheelchair can sit and be anchored by way of seat belts, floor clasps, or a combination of both. The problem arises in moving the patient and the wheelchair into and out of the vehicle, since the floor of the vehicle sits anywhere from one to two feet off the ground. In the past, and even at present, solid ramps, mainly made of wood, have been constructed for use at a patient's home, for example, to allow a wheelchair and patient to be moved into and out of a transport vehicle. The obvious disadvantage of such ramp structures is that they cannot be taken in the transport vehicle to be used when the vehicle gets to its selected designation to allow the handicapped person to readily leave the vehicle. In addition, such solid ramp structures must be stored somewhere, such as in the garage at the home of the handicapped person, thus taking up valuable storage space.

Prior ramp structures do not take into consideration the storage of such structures when not being used, such as when the vehicle, railroad car, boat, etc. is being used to transport people without disabilities. The ramp structure will usually be stored in a garage, basement, shed or the like, and must be lightweight and mobile enough to be easily moved between a storage space and the vehicle, and vice versa, when required. Additionally, prior ramp assemblies do not suggest that the same ramp assembly may also be used in combination with an auxiliary device or devices to provide handicap access and egress up and down steps leading to a building entrance after a disabled person has been transported by a vehicle to the building entrance.

In the past, several loading ramp type devices of the non-fully expandable and retractable type have been developed in an effort to provide the ability to load materials onto vehicles, particularly into the cargo beds of trucks. Such prior loading ramps are disclosed by way of example, in U.S. Pat. No. 1,201,790, No. 3,352,440; No. 3,713,553; No. 3,870,170, and No. 4,290,728. None of the ramps disclosed in these patents are fully expandable and retractable, nor are any of the disclosed ramps capable of being substantially folded into a small footprint when not in use. In addition, these prior ramps are not constructed to enable the folded ramp to be pivotally moved out of the doorway of a van, railroad car or boat when not in use.

An expandable and retractable lazy-tong type ramp structure is shown in Archer U.S. Pat. No. 4,527,941. This device incorporates a pair of lazy-tong or foldable scissors mechanisms for creating a storable ramp, wherein the floor of the structure is formed by wooden planks extending between parallel extending scissors linkages, or planks of steel reinforced with ribs or flanges. In either situation, wooden or steel planks would result in a ramp structure that would be too heavy for manual manipulation upon expanding and retracting the ramp, or even removing the ramp structure from the vehicle when not in use. In addition, the Archer patent does not teach or suggest that the ramp, when folded, can be pivotally moved out of the entrance door of a vehicle when not in use.

In addition, the horizontal planks in the Archer device rely on the strength of each individual plank to be able to support loads on the ramp. If one of the wooden planks has a flaw, that plank may fail under load, increasing the distributive weight carried by each of the remaining planks. This added weight may cause failures in other wooden planks. There is no teaching or suggestion in the Archer reference how the planks, made either of heavy wood or steel, would be reinforced while keeping the total weight of the ramp structure at a minimum for manual manipulation, or removal from the vehicle by hand.

Further, the Archer device does not include a compression apparatus to prevent the scissors mountings and ramp tread plates from locking out, going over center or expanding to a flat configuration, when the ramp is expanded.

In view of the above, an object of the present invention is to provide a lightweight, manually manipulative expandable and retractable ramp for loading and unloading handicapped persons in wheelchairs and the like into a van, mini-van, railroad car, boat or other similar vehicle.

Another object of the present invention is to construct the afore-described ramp with sufficient internal structural strength to allow heavy wheelchair devices carrying a handicapped person and an aide pushing the wheelchair to be supported by the ramp, as well as heavier motorized wheelchairs.

Another object of the present invention is to provide an expandable and retractable ramp for loading and unloading mobile objects and persons supported in and assisting with such mobile objects onto and from a vehicle having a raised floor, wherein the platform treads functioning as the horizontal load bearing elements of the ramp comprise a plurality of lightweight, horizontal, tubular configured beams having reinforced tread plates extending and absorbing stresses between the beams, while the tread plates include counter sunk apertures to decrease the weight of the ramp and simultaneously add strength to the tread plates.

Further, an object of an embodiment of the present invention is to provide an expandable and retractable ramp for mounting inside of a van or similar vehicle, wherein the ramp, in its retracted position, is rotatably movable to a storage position in the vehicle to allow storage of the retracted ramp in the vehicle wherein the stored ramp does not interfere with access into or egress from the vehicle by other persons.

Yet another object of the present invention is to provide an expandable and retractable ramp for loading and unloading objects onto and off of a vehicle, wherein the ramp employs a lazy-tong or scissors mechanism with a unique compression bumper assembly that prevents the scissors mechanism and the tread plates of the ramp from locking out over one hundred eighty degrees when the ramp expands toward an over-center or horizontal position.

A further object of the present invention is to provide a foldable and expandable ramp for supporting wheelchair-bound persons and their aides as the wheelchair and persons are rolled into an automotive van, railroad car, boat or other vehicle from the ground level, which ramp can also be removed from the vehicle and readily mounted on a wheeled hand cart or similar moving device for transport and storage when the ramp is not needed in the vehicle.

Another object of the present invention is to provide a unique connecting assembly to pivotally mount the ramp assembly on a moveable hand cart, whereby the ramp assembly can be transported to the top of a set of stairs, or on one side of an opening in the ground, such as a pit. The ramp assembly is then expanded over the steps or pit to provide handicap access up and down the steps or over the opening in the ground.

A further object of an embodiment of the present invention is to provide an extendable and retractable ramp that permits a patient-bearing stretcher to be easily loaded into and taken off of the deck of an ambulance while reducing the load to be lifted by an EMT.

### SUMMARY OF THE INVENTION

An expandable and retractable ramp assembly is provided for conveying moving objects such as wheelchair bound patients and their aides into a van, railroad car, boat or other vehicle or passenger conveyance, the ramp assembly in an embodiment having a dual mounting plate assembly allowing the retracted ramp assembly to be pivotally moved when retracted in the vehicle so that the ramp assembly does not interfere with other persons entering or leaving the vehicle. In this embodiment, the expandable and retractable ramp assembly is removably and pivotally mounted to the vehicle for linear expansion and contraction and rotative movement, the rotative movement being in a direction at right angles to the directions of expansion and contraction of the expandable ramp. The ramp assembly also comprises a pair of parallel disposed scissors assemblies and a tread support assembly extending between and operatively connected to the pair of parallel scissors assemblies. The tread support assembly includes a plurality of tread plates each connected to a plurality of tubular support members. The support members are securely fastened to the scissors assemblies, and the tread plates and support members are adapted to support and distribute, in combination, loads on the expanded ramp assembly. Each of the tread plates includes a plurality of apertures extending through the tread plates, providing both strength and light weight to the tread assembly. Raised rims are circularly disposed about each aperture, the raised rims also providing a gripping surface on the tread plates. The scissors assemblies include unique cushioning elements, such as compression bumper assemblies, to prevent the scissors mechanism and tread plates from locking out over one hundred eighty degrees. In addition, gripping hooks are provided at an outer portion of the scissors assembly allowing the extended ramp to be moved to an initial position through potential locking forces in the system, enabling the retraction process to commence unimpeded.

The present inventive system also includes a uniquely constructed manual transportation truck or cart upon which the retracted ramp assembly is removably mounted when the ramp assembly is not in use in the vehicle. The cart permits the retracted ramp assembly to be stored in a garage, basement, shed or the like having a relatively small footprint when compared to the expanded length of the ramp. When mounted on the cart, the ramp assembly can also be readily moved into position over a set of steps, allowing a disabled person in a wheeled chair to go up or down over the steps subsequent to use of the ramp assembly to remove the disabled person from the vehicle.

In an embodiment, the present invention provides a ramp assembly that is adapted to be removeably installed in standard sized automotive vans having a space on the floor of the vehicle between the rearmost edge of the side door and the wheel well protruding upward from the floor. In such vans, adequate space is provided between the rear door edge and the wheel well to allow the retracted ramp assembly to be pivoted in a direction normal to the direction of linear expansion, and stored out of the way in the space between the rear door edge and the protruding wheel well.

In a further embodiment, the present invention provides a removable ramp assembly structure that is adapted to be installed in smaller type automotive vans that are currently being marketed, known as “mini-vans.” In mini-vans, there is no space between the rear of the side door opening and the protruding wheel well to locate the retracted ramp assembly. In this embodiment, the retracted ramp assembly either remains in place in the mini-van during transport adjacent the closed side door, or the retracted ramp assembly is removed from its mounting platform and situated at another location in the mini-van. This embodiment of the ramp assembly for mini-vans is also capable of being mounted on a cart and expanded over a pair of steps, allowing the disabled person to use the expanded ramp assembly to proceed up or down the steps when not in the vehicle.

In an additional embodiment, an extendable and contractable ramp of a predetermined length is pivotally and removably attached adjacent the rear of the deck of an ambulance. The ramp extends outward to receive the front wheels of a patient-bearing ambulance stretcher, and lift the stretcher onto the deck when the stretcher is moved into the ambulance by the EMT. The ramp is hinged to a plate attached to the ambulance deck, and if necessary, tilts ninety degrees upward and out of the direct path of the stretcher during the loading or unloading process.

### BRIEF DESCRIPTION OF THE DRAWINGS

The above and other objects and advantages of the present invention as hereinafter described will become apparent from reference to the detailed description of the illustrated embodiments as set forth below, and the accompanying drawings, wherein:

FIG. 1 is a side perspective view of the expandable and contractable ramp of the present invention, shown in its expanded position with a wheelchair bound person shown in phantom advancing along the ramp;

FIG. 2 is a side perspective view of the ramp assembly of FIG. 1, showing the ramp assembly in a partially contracted position;

FIG. 3 is a detail elevation view of a portion of the scissors assembly used in the expandable and contractable ramp of the present invention;

FIG. 4 is a perspective view of the ramp assembly of FIG. 1, showing the ramp assembly in its contracted position after being moved laterally as shown in FIG. 2;

FIG. 5 is a perspective view of the ramp assembly of FIG. 1, shown in its contracted or folded position, and after the folded ramp assembly is pivoted approximately ninety degrees from the position shown in FIG. 4 and onto a first or upper support plate;

FIG. 6 is another perspective view of the ramp assembly in the position shown in FIG. 5, taken from the opposite side of the ramp assembly shown in FIG. 5 and showing the self centering legs and corresponding leg mounting assemblies;

FIG. 7 is a detail elevation view of a self centering leg and mounting assembly of the present invention, showing the leg in its retracted position;

FIG. 8 is a detail perspective view of the spring mount for the self centering legs of the present invention, showing the leg in a partially rotated position from its holding clamp;

FIG. 9 is a perspective detail view of a portion of the underside of the ramp assembly shown in FIG. 1, showing the tubular supports for the treads of the ramp assembly;

FIG. 10 is another perspective detail view of a portion of the underside of the ramp assembly shown in FIG. 1;

FIG. 11 is a perspective view of the ramp assembly of FIG. 1, shown in the contracted position and rotated ninety degrees away from the second or lower support plate attaching the ramp assembly to the vehicle in which the ramp assembly is installed;

FIG. 12 is a detail perspective view of the pivotal mounting assemblies between the ramp assembly and the upper support plate, and between the upper and lower support plates, of the ramp assembly of FIG. 1;

FIG. 13 is a detail perspective view of the pivotal mounting assemblies shown in FIG. 12;

FIG. 14 is a detail perspective view of the compression absorber of the present invention, showing the compression absorber mounted on one of the bracket assembly plate members of the scissors mechanism of the present invention;

FIG. 15 is another detail perspective view of the compression absorber of FIG. 14, shown in the compressed position;

FIG. 16 is another detail perspective view of the compression absorber of FIG. 14, shown mounted to one of the bracket assembly plate members of the scissors mechanism of the present invention;

FIG. 17 is a detail perspective exploded view of the locking mechanism between the upper and lower mounting plates of an embodiment of the present invention shown in the open or unlocked position;

FIG. 18 is a detail perspective view of the locking mechanism between the upper and lower mounting plates of the embodiment of FIG. 17, shown in the closed or locked position;

FIG. 19 is a perspective view of a uniquely constructed mobile truck or hand cart assembly adapted to removably receive and support the ramp assembly when the ramp assembly is folded into the contracted position shown in FIG. 5, and when the ramp assembly is expanded to provide handicap access up and down a flight of steps as seen in FIG. 25;

FIG. 20 is a detail view of the connecting brackets of the hand cart and the pivotal ramp assembly support plate of the hand cart shown in FIG. 19;

FIG. 21 is a perspective view of the hand cart of FIG. 19, showing the ramp assembly support plate of the hand truck rotated into a vertical or storage position;

FIG. 22 is a detail perspective view of one of the attachment blocks and the pivot connection of the hand cart of FIG. 19;

FIG. 23 is a perspective view of the ramp assembly support plate of the hand cart of FIG. 19, showing the support plate mounted on the opposite side of the hand cart;

FIG. 24 is a perspective view of an embodiment of a ramp support plate assembly adapted to be installed in smaller vehicles and other transport devices, shown with the ramp assembly removed from the hand cart;

FIG. 25 is an elevation perspective view of the ramp assembly of the present invention in an extended position over a flight of stairs, shown extended from the hand cart and with intermediate foot assemblies extended to properly support the ramp assembly when in use;

FIG. 26 is a perspective view of an embodiment of the expandable and contractable ramp assembly of the present invention, removably attached adjacent the rear of an ambulance deck, with the ramp assembly extended outward from the ambulance deck;

FIG. 27 is a schematic perspective view of the ramp assembly embodiment of FIG. 26, showing the position of the front wheels of an ambulance stretcher when the stretcher is in position to be loaded into the ambulance;

FIG. 28 is a perspective view of the ramp assembly embodiment of FIG. 26 shown in the contracted position seated adjacent the rear end of the ambulance deck; and

FIG. 29 is a view of the ramp assembly being pivoted out of the direct path of the stretcher when the ramp assembly is not required to load or unload a stretcher.

### DETAILED DESCRIPTION OF THE ILLUSTRATED EMBODIMENTS

The present invention provides an expandable and contractable ramp assembly for moving heavy objects, for example, handicapped persons in movable chairs, such as wheelchairs, along with their aides, into and out of vehicles and transport devices, such as automotive vans, mini-vans, railroad cars, boats, and the like. The present invention is designed to support loads in the range of 800 to 900 pounds, and to be manually contractable. In an embodiment, the ramp assembly of the present invention is angularly movable for storage in the vehicle or other transport device when not in use, out of the path of others entering and leaving the vehicle. In addition, the contracted ramp can be readily detached altogether from the vehicle or device in which it is used, to allow the ramp to be moved into storage when not being used, enabling the vehicle or device to engage in its normal use.

The ramp assembly of the present invention is also used in conjunction with a unique hand movable truck or cart assembly to which the ramp assembly can be removably attached. The cart assembly has a relatively small footprint, enabling a contracted ramp assembly when mounted on the cart to be readily stored. The cart also provides a base from which the ramp assembly can be extended over a set of stairs or over an open pit, allowing a handicapped person in a wheelchair to use the ramp to go up and down the stairs over the ramp surface, or over the pit.

In a separate embodiment of the invention, a ramp assembly and a base structure are configured to enable the expandable and contractable ramp assembly to be installed in a van that is smaller than the normal van. These smaller vehicles are popularly known as “mini-vans.” The manually moveable truck or cart of the present invention is also adapted to be used with the “mini-van” embodiment of the present invention.

The disclosed ramp assembly utilizes a uniquely reinforced scissors, or lazy tong, expandable and contractable tread support mechanism. In an embodiment, the tread support mechanism is constructed to be pivoted out of the entrance way of a vehicle when in the folded or contracted position.

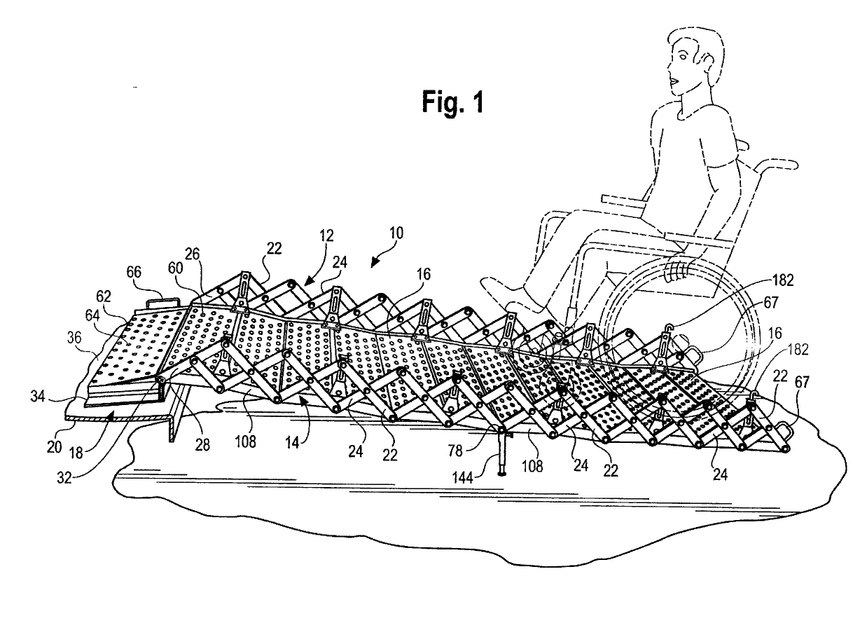

Referring to FIG. 1, the ramp assembly is generally designated by the numeral 10. The ramp assembly 10 generally comprises opposing expandable and contractable parallel scissors assemblies 12 and 14, with a tread support assembly 16 extending between and attached to certain links of the scissors assemblies 12, 14 as will be described. The ramp assembly 10 also includes a unique mounting assembly 18 that is used to pivotally and detachably attach the ramp assembly 10 to an entrance platform 20 of a van or other vehicle with which the ramp assembly 10 is used. It is understood that the ramp assembly 10 could likewise be installed in a railroad car, boat, or other passenger transport device. When the ramp assembly 10 is installed in an automotive van 20, by way of example, the ramp assembly is mounted on the van floor adjacent the side door (either slidable or pivotal) that provides access to the inside of the van. If access to the vehicle is via the rear door or doors, the ramp assembly 10 is mounted on the floor adjacent the rear door.

As illustrated in FIGS. 1-4, the scissors assemblies 12, 14 each comprise a plurality of double linkage assemblies 22 and single linkage assemblies 24, to be described later in detail. Each scissors assembly 12, 14 has a single link 26, 28, respectively, at one end of each scissors assembly. As viewed in FIGS. 1-3 and 12, the lower end of each end link 26, 28 includes an aperture 30 adapted to removably receive a releasable mounting pin 32 with a grip ring 54.

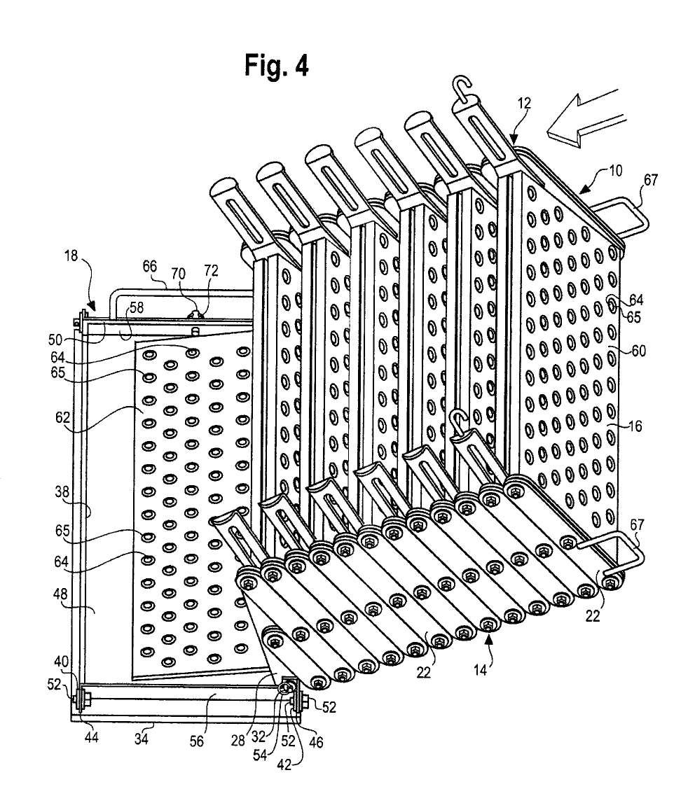

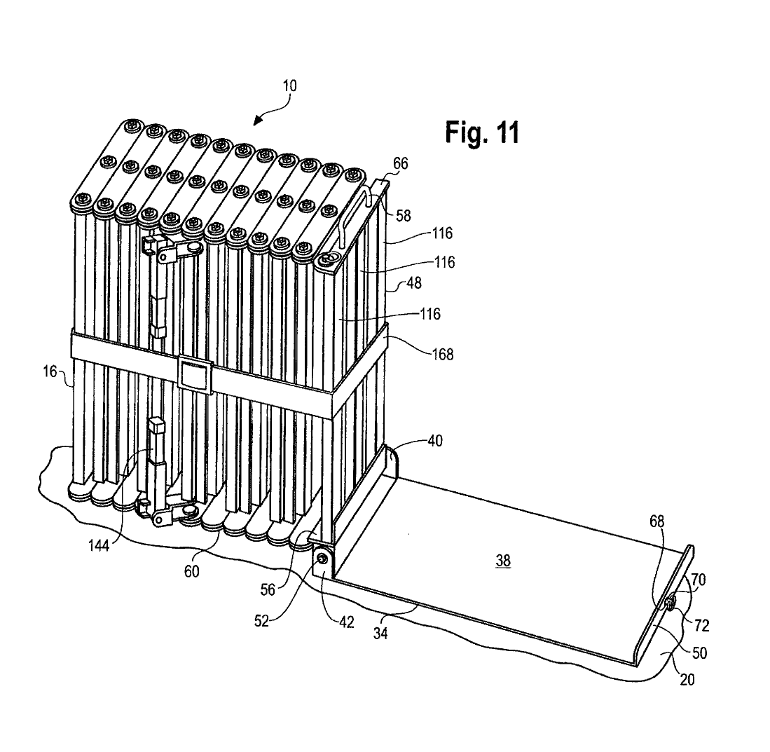

Referring to FIGS. 1-4 and 11-13, mounting assembly 18 includes a lower mounting plate 34 secured to the floor 36 of the entrance platform 20 of the vehicle in which the ramp assembly 10 is to be installed. Lower mounting plate 34 has an upwardly facing, substantially flat surface 38 and vertically extending flange pairs 40, 42 at one end of the mounting plate 34 (FIGS. 4, 11).

Each flange pair 40, 42 includes a narrow space between each adjacent flange, the space adapted to receive flanges 44, 46 forming part of upper mounting plate 48 as will be explained. An upstanding flange 50 (FIG. 4) is located on the opposite end of lower mounting plate 34 from flange pairs 40, 42.

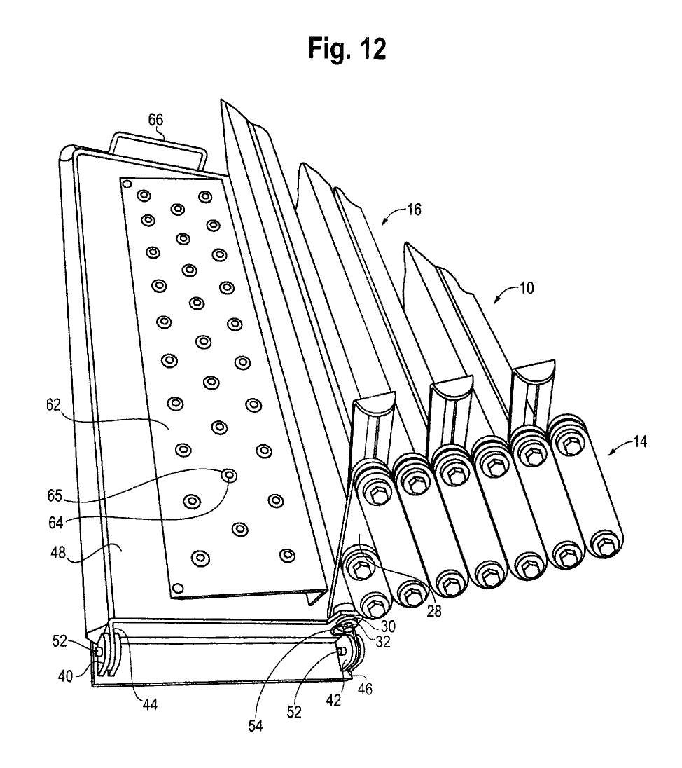

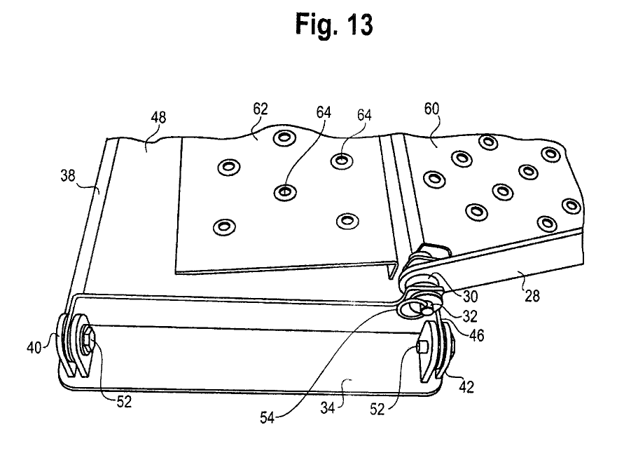

Nested between flange pairs 40, 42 and flange 50, and resting on lower mounting plate 34, is upper mounting plate 48. As seen in FIGS. 12 and 13, flanges 44 and 46 are attached to and extend laterally outward from upper mounting plate 48. Each flange 44, 46 has an aperture extending therethrough (not shown), and these apertures are aligned with corresponding apertures in flange pairs 40 and 42. A bolt and nut assembly 52 is inserted through the aligned apertures in each flange pair 40, 42, thus pivotally mounting upper mounting plate 42 to lower mounting plate 34, for reasons to be explained.

Referring to FIG. 4, upper mounting plate 48 includes a first upstanding flange 56 at one end, and a second upstanding flange 58 at an opposite end. Each flange 56, 58 includes an aperture (not shown) which is aligned with apertures 30 (FIG. 12) located at the terminus of each of the end links 26, 28 of scissors assemblies 12, 14. By gripping ring 54 and removing pin 32 from apertures 30 (FIGS. 12, 13), scissors assemblies 12, 14 and tread support assembly 16 can be detached from upper mounting plate 48 (FIG. 4). For this reason, the ramp assembly 10 must be light enough in weight to be manually lifted and transported, yet strong enough to support a moving load of a wheelchair, handicapped person in the wheelchair, and an aide pushing the wheelchair, including motorized wheelchairs. In the illustrated embodiment, the scissors assemblies 12, 14 and tread plate assembly 16 are made of aluminum or other suitable lightweight material.

As best seen in FIGS. 1-3, the tread support assembly 16 includes a plurality of tread plates 60, including one tread plate that is closest to upper mounting plate 48. When the scissors assemblies 12, 14 are fully expanded, as seen in FIG. 1, the left end of the one tread plate 60 is elevated relative to the plane of upper mounting plate 48. To provide smooth transport of the wheelchair and the person in the wheelchair into or out of the vehicle represented by platform 20, a slanting tread plate 62 is mounted on the top of upper mounting plate 48. As viewed in FIGS. 1, 2 and 12, the right side of tread plate 62 is elevated to match the height of the left end of tread 60, while the left side of tread plate 62 extends downward to the height of upper mounting plate 48 (FIG. 12). Tread plate 62 includes upwardly extending countersunk apertures 64 to add strength to plate 62 while reducing the weight of the tread plate.

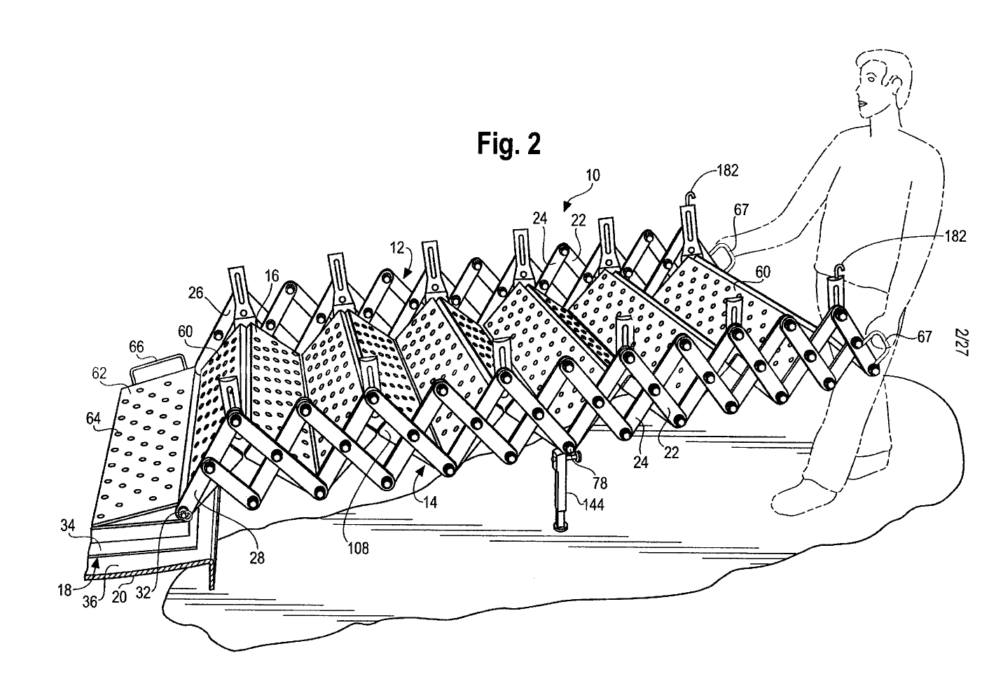

A handle 66 (FIGS. 1, 2 and 4-6) is secured to flange 58 at the end of upper mounting plate 48 that is opposite flanges 44, 46. As will be explained, a user, by gripping handle 66 and lifting, can rotate upper mounting plate 48, contracted scissors assemblies 12, 14 and tread support assembly about bolts 52 into the position shown in FIG. 11. Additional handles 67 (FIGS. 1-2) are attached to the outermost double linkage assemblies 22 of scissors assemblies 12, 14 to provide manual gripping of the ramp assembly during expansion and contraction of the ramp assembly, as will be explained.

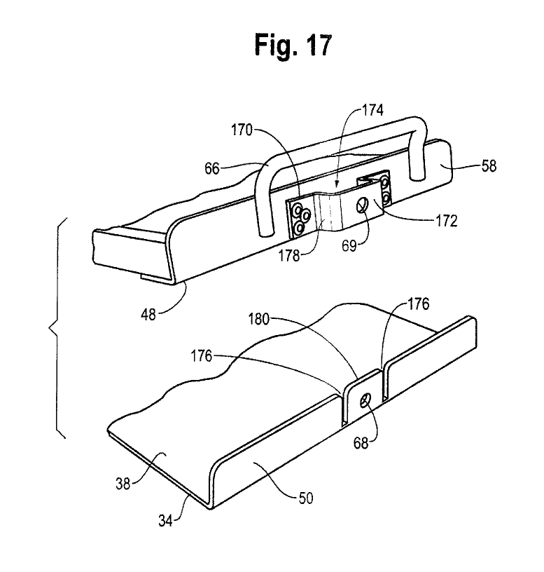

When upper mounting plate 48 is in the position shown in FIGS. 1 and 5-6, upper mounting plate 48 is adjacent and rests upon surface 38 of lower mounting plate 34. It is important when ramp assembly 10 is in use that upper mounting plate 48 be secured against rotative movement off of lower mounting plate 34. To this end, in an embodiment, flange 50 (FIG. 17) of lower mounting plate 34 includes an aperture 68 that aligns with a corresponding aperture 69 in U-shaped bracket 170 that is securely fastened to flange 58 of upper mounting plate 48. U-shaped bracket 170 includes a flat surface 172 in which aperture 69 is disposed, with a space 174 generated between aperture 69 and the outer surface of flange 58. Flange 50, extending upward from lower mounting plate 34, includes a pair of grooves 176 that are spaced apart the same distance that side surfaces 178 of bracket 170 are separated. Between grooves 176 a tongue portion 180 of flange 50 is formed.

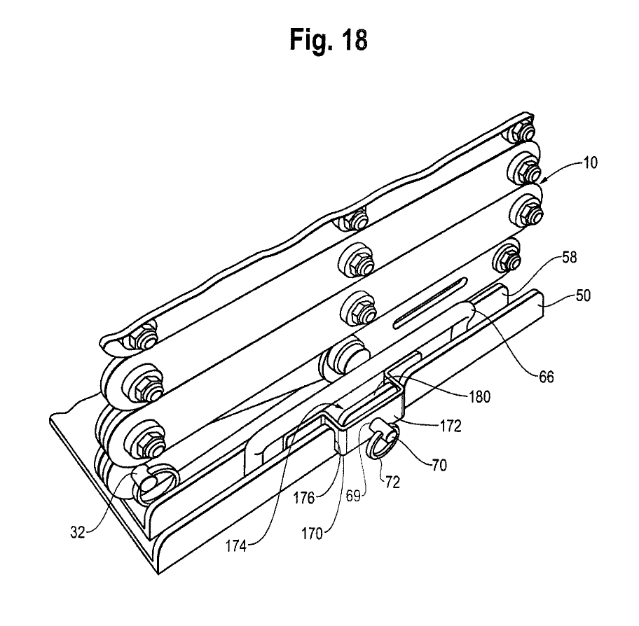

In FIG. 17, upper mounting plate 48 is shown in a partially raised position relative to lower mounting plate 34. As upper mounting plate 48 is lowered to rest upon surface 38 of lower mounting plate 34, side surfaces 178 of bracket 170 enter and lodge in grooves 176, and tongue portion 180 of flange 50 enters and lodges in the space 174 formed between flat surface 172 the outer surface of flange 58. In this latter position, aperture 68 in tongue portion 180 aligns with aperture 69 in bracket 170. A releasable locking pin 70 (FIG. 18) with a finger grip ring 72 is inserted through aperture 68 and the corresponding aperture 69 in flange 170, thus securing the upper mounting plate 48 against movement relative to the lower mounting plate 34. When it is desired to rotate the ramp assembly 10 into the position shown in FIG. 11, locking pin 70 is withdrawn from apertures 68 and 69, allowing upper mounting plate 48 to rotate relative to lower mounting plate 34.

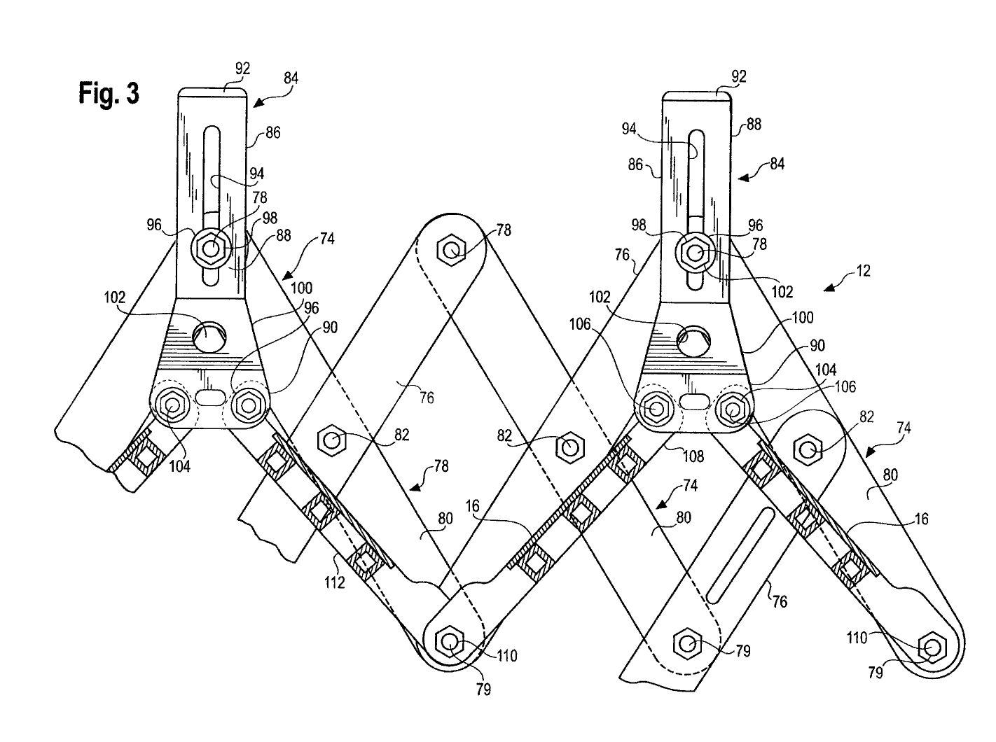

Referring to FIGS. 1-6, 11 and 12, and particularly FIG. 3, ramp assembly 10 comprises two parallel scissors assemblies 12, 14 that are mirror images of each other. The description of one scissors mechanism herein is intended to apply equally to the opposite scissors mechanism. Each scissor mechanism 12, 14 in the illustrated embodiment comprises a plurality of parallel double linkage assemblies 74 (FIG. 3) that are pivotally connected to single linkage members 76 at or adjacent the opposite ends of each double link assembly 74 and each adjacent single linkage member 76, by means of bolts 78 at one end and bolts 79 at the opposite ends of the link assembly. Single linkage members 76 extend between the individual links 80 forming double linkage assembly 74, and the individual links 76 are pivotally connected at their center point to each link 80 by a bolt 82. The above described linkage assembly is known in the art as a “lazy-tong” device, and is used to provide expandable and retractable mechanisms for various uses.

Alternating bolts 78 each have a sliding mounting bracket assembly 84 movably attached thereto for providing an operative connection between the scissors assemblies 12, 14 and the tread support assembly 16. As best seen in FIG. 3, each bracket assembly 84 comprises a plate member 86 having a generally planar upper portion 88, and a lower portion 90 extending in a parallel but different plane than upper portion 88. Upper portion 88 includes an upper flange 92 extending ninety degrees outward from the top of upper portion 88.

The upper portion 88 of each plate member 86 includes a substantially linear slot 94 through which a portion of bolt 78 extends, allowing relative movement of sliding mounting bracket assembly 84 around and along the axis of bolt 78. Bolt 78 is operatively connected to bracket assembly 84 using suitable washers 96 to mitigate friction and a sufficiently strong threaded nut 98 as is known in the art (FIG. 3).

The lower portion 90 of plate member 86 extends in a second parallel plane relative to the plane of upper portion 88, and the upper portion 88 is connected to the lower portion 90 by an angle piece 100. An aperture 102 extends through plate member 86 to reduce the weight of the plate member.

The lower portion 90 of plate member 86 comprises a pair of apertures 104, through which each aperture a bolt 106 extends, pivotally attaching the lower portion of each plate member 86 to one end of a pair of linkage assemblies 108 that form part of tread support assembly 16, as will be described. Linkage assemblies 108 extend in opposite directions from plate member 86, and are pivotally connected to plate member 86 by means of bolts 110, as is known in the art.

As seen in FIG. 3, the opposite end of each linkage assembly 108 is pivotally connected by bolt 79 to the lower end 112 of alternate double linkage assemblies 74 and single linkage members 76. As will be explained in more detail, as sliding mounting bracket assembly 84 moves relative to bolt 78, linkage assemblies 108 will pivot about the corresponding bolt 79 between a somewhat horizontal to a somewhat vertical position.

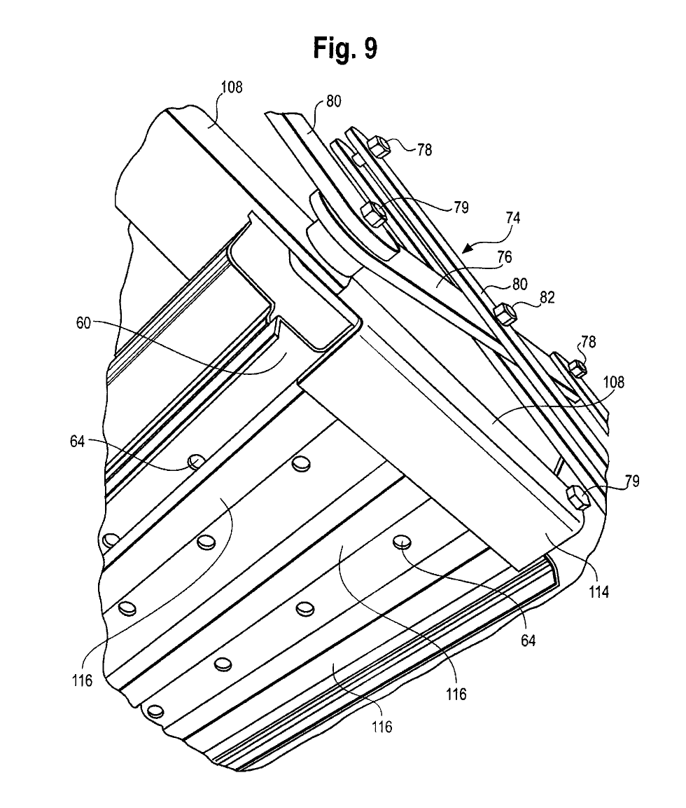

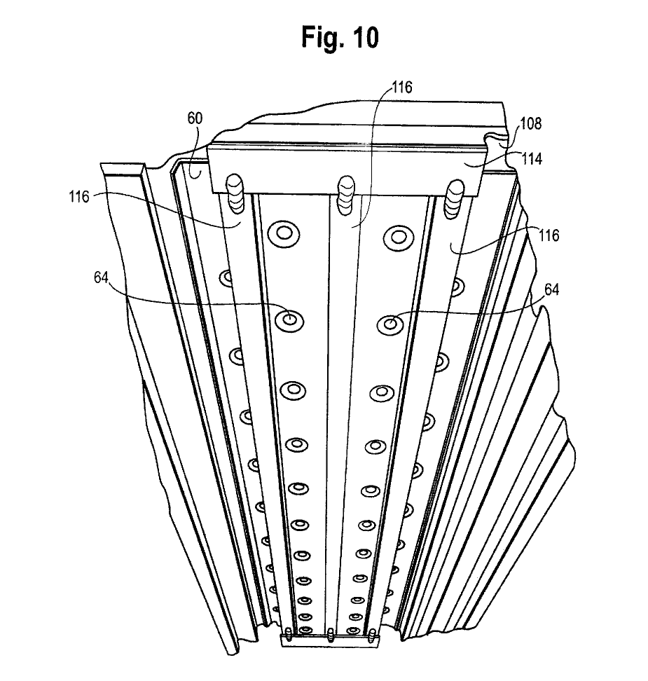

Each linkage assembly 108, as mentioned, is part of tread support assembly 16. The tread support assembly, as well as the scissors assemblies 12, 14 are specifically constructed and reinforced to support moving objects in the range of 800 to 900 pounds, or even higher. To this end, each linkage assembly 108 includes a flange 114 extending ninety degrees from the plane of linkage assembly 108. As seen in FIGS. 9 and 10, a plurality of tubular support members 116 are securely fastened by suitable means known in the art, such as welding for example, to opposing flanges 114 of opposing linkage assemblies 108. In the illustrated embodiment, three tubular support members 116 are shown extending between flanges 114, however less or more tubular support members may be utilized in accordance with a predetermined balance between load requirements and total ramp weight requirements. Also, in the illustrated embodiment, tubular support members 116 are shown as having a square tubular cross-sectional configuration, however it is understood that other cross-sectional configurations such as round, triangular and C-shaped may be utilized to maximize the load capacity of ramp 10.

In the illustrated embodiment of FIG. 9, tread plates 60 extend between and are securely fastened to each of the tubular support members 116. As previously described, ramp assembly 10 of the present invention is specifically constructed to support heavier moving loads than devices shown in the prior art, while at the same time allowing the ramp to be manually manipulated and moved from place to place for installation, removal and storage. To this end, tread plates 60 are made of relatively thin sheet material, but have sufficient strength in tension to prevent adjacent tubular support members 116 to which the tread plates 60 are connected from moving away from each other under load. In addition, each tread plate 60 comprises a plurality of countersunk apertures 64 having raised rims or edges 65 (FIGS. 4, 12) that provide additional tensile strength, as well as a gripping surface on the tread plates 60. The apertures 64 also aid in reducing the total weight of ramp assembly 10.

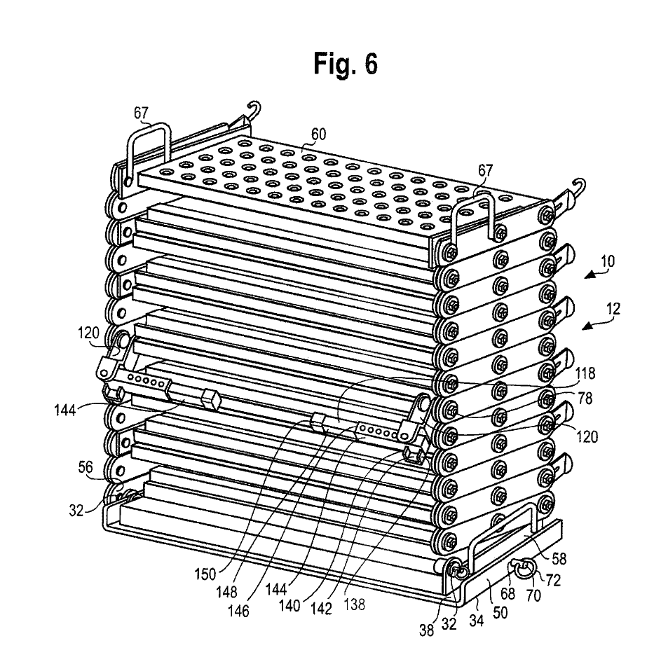

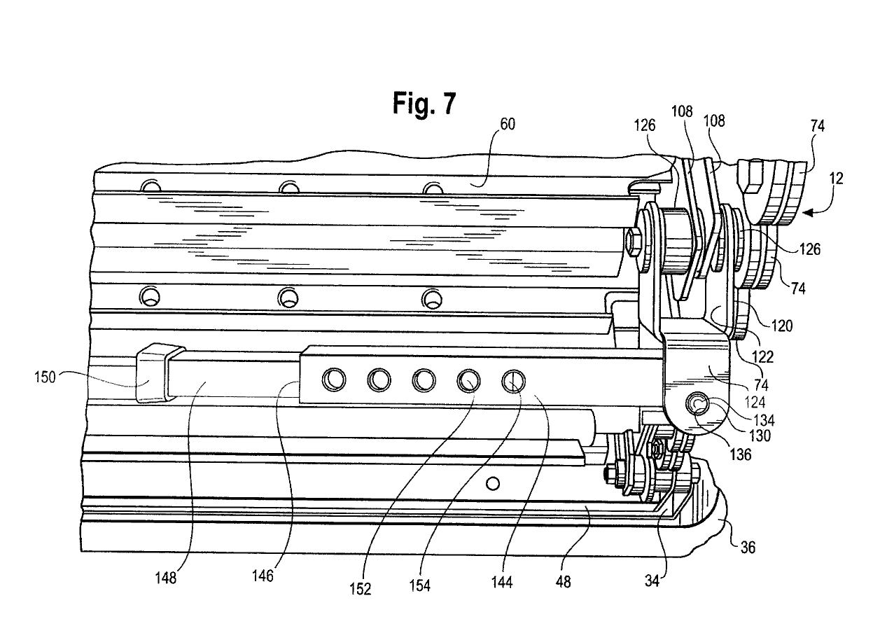

To provide additional support for ramp assembly 10 when in use, referring to FIGS. 1 and 2, a self centering leg assembly 144 is pivotally attached to each scissors assembly 12, 14. Referring to FIGS. 6, 7 and 8, leg assembly 144 includes a generally double U shaped bracket 120 pivotally mounted on one of the bolts 78 of scissors assembly 12. Bracket 120 has a first U shaped section 122 and a second U shaped section 124, second section 124 disposed at a right angle to section 122. First U shaped section 122 comprises a pair of aligned apertures (not shown) through which bolt 78 passes to loosely and rotatably mount bracket 120 to scissors mechanisms 12 and 14. Bolt 78 also extends through aligned apertures (not shown) in a plurality of washers 126, and through aligned apertures (not shown) in linkage assemblies 108 (FIG. 7).

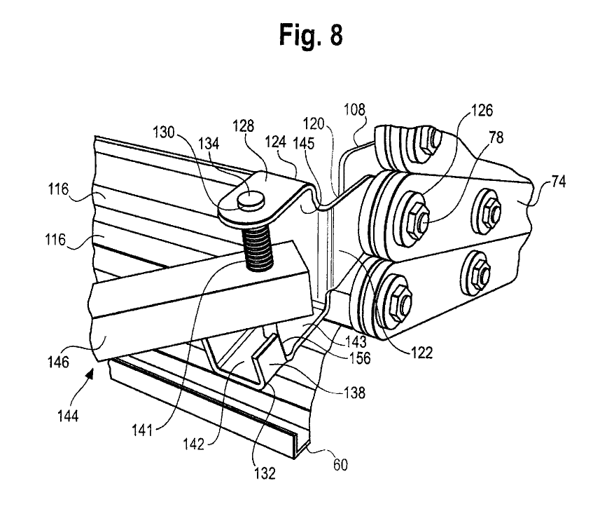

Second U shaped section 124 of bracket 120, as best seen in FIG. 8, comprises a first side flange 128 having an aperture 130 extending therethrough. Also forming part of second U shaped section 124 is a second side flange 132, with an aperture (not shown) aligned with aperture 130 in first side flange 128. Bolt 134 extends through aperture 130 and the aligned aperture in second side flange 132, and is firmly held in place by a C locking washer 136 (FIG. 7).

Second side flange 132 also comprises a pair of opposed flanges 138, 140 forming a receptacle 142 between flanges 138, 140. A gap 143 in U shaped section 124 is formed between the edges of flanges 138, 140 and the top surface 145 of second U shaped section 124 of bracket 120.

In the illustrated embodiment of FIGS. 6, 7 and 8, a tubular leg assembly 144 is pivotally mounted on bolt 134, and a spring 141, in compression, is also mounted on bolt 134 between first side flange 128 and leg assembly 144, the spring 141 biasing the leg assembly 144 downward as viewed in FIG. 7 in the direction of receptacle 142 and gap 143.

Tubular leg assembly 144 of the illustrated embodiment comprises a first tubular section 146, and a second tubular section 148, the second tubular section 148 slidably inserted into the first tubular section 146. A plastic or rubber footer 150 fits over the end of second tubular section 148 that is opposite the end inserted in first tubular section 148. First tubular section 146 comprises a plurality of spaced apart apertures 152 adapted to receive a releasable spring-loaded locking pin 154 to allow the height of leg assembly 144 to be suitably adjusted.

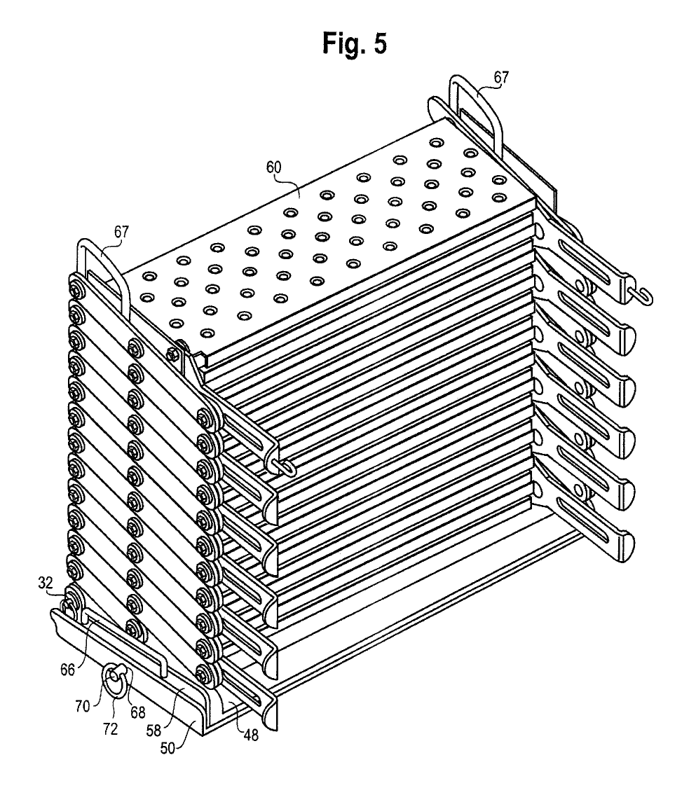

When ramp assembly 10 is not in use, leg assembly 144 is in the position shown in FIGS. 6 and 7. Referring to FIGS. 5, 6 and 7, the end of first tubular section 146 adjacent bolt 134 is disposed in gap 143, with the spring 141 biasing one side of leg assembly 144 against the wall of second side flange 132 forming gap 143. In this position, another side wall of first tubular leg section 146 is held against the two side edges 156 of flanges 138, 140 (only one shown in FIG. 8). Thus, spring 141 keeps leg assembly 144 in its retracted position as shown in FIGS. 6 and 7 when the ramp assembly is in its stored or non-use configuration.

When it is desired to move the leg assemblies 144 into their supporting or use position, each leg assembly 144 is manually gripped and slid axially along bolt 134 against the force of spring 141 until the side of first tubular section 146 of leg assembly 144 is free of contact with side edges 156 of flanges 138, 140. The leg assembly 144 is then pivoted ninety degrees around bolt 134 until first tubular section 146 is parallel with flanges 138, 140, and the leg assembly 144 is forced by the bias of spring 141 into receptacle 142 between flanges 138, 140. Flanges 138, 140 and spring 141 hold leg assembly 144 against pivotal or lateral movement and in its usable position. After use, the leg assembly 144 is again moved along bolt 134 against the force of spring 141, and rotated ninety degrees until an end of first tubular section 148 is returned to gap 143 under the bias of spring 141.

When in their use position, leg assemblies 144 are first adjusted to the proper height between ramp assembly 10 and the ground or other support surface beneath the leg assemblies by adjusting the relative position of second tubular leg section 148 in first tubular section 146, and locking the two leg sections 146, 148 together by manipulating spring loaded locking pin 154. In an embodiment, all structural elements of the ramp assembly 10 are made of aluminum, enabling the ramp assembly to “give” to a certain degree as a load is moved up or down the ramp assembly 10. Therefore, when adjusting the height of leg assemblies 144, it may be desirable to set the height of leg assemblies 144 so that footer 150 will not touch the ground or other support surface until a load is applied to the ramp assembly. It is also possible to adjust the height of the leg assemblies to contact the ground or other support surface when the ramp assembly 10 is in its unloaded position.

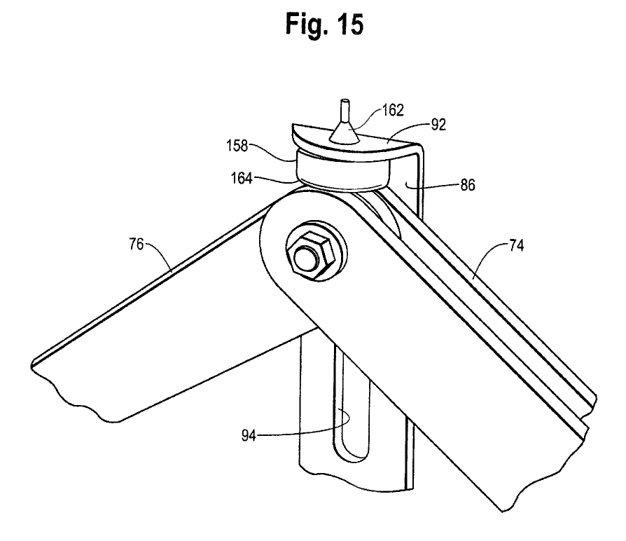

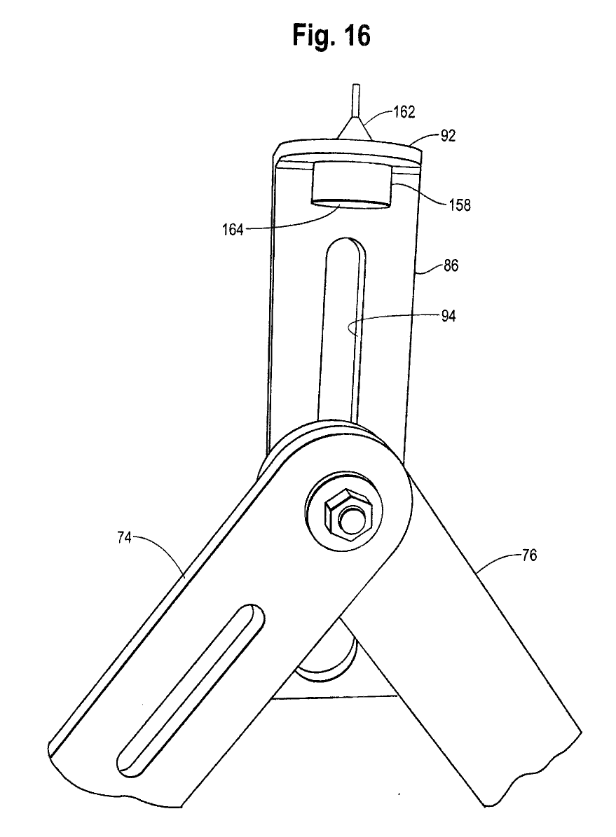

As is readily apparent, the disclosed ramp assembly 10 is adapted to be extended and contracted each time the ramp assembly is used, utilizing scissors assemblies 12, 14. As seen in FIGS. 1, 3 and 14-16, when a load is moving on tread plates 60, a downward force is applied to linkage assemblies 108 and to sliding mounting bracket assembly 84. Under certain load conditions, linkage assemblies 108 may be in a flat position, where all of the linkage assemblies 108 are in a straight line. Or, the position of bolts 106 may be below the position of bolts 110, causing an “over-center” situation. If a flat or over-center position occurs, as just described, it may be difficult or impossible to retract ramp assembly 10 once it has been expanded and used to support a heavy load.

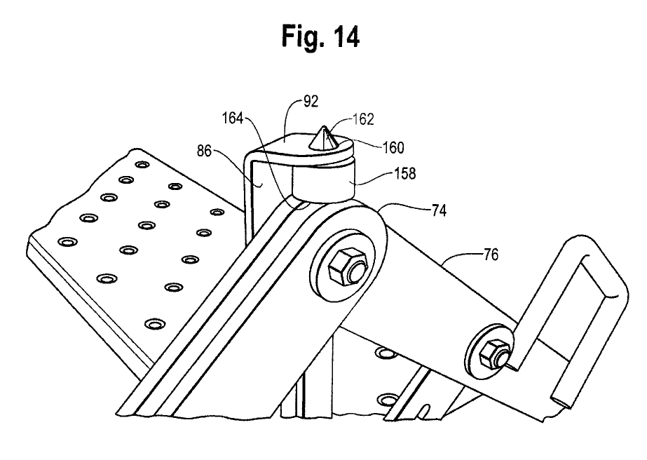

To remedy these potential undesirable over-center and flat situations, one embodiment of the present invention provides a compression cushion or bumper assembly (FIGS. 14, 15, 16) to return the scissors assemblies 12, 14 to a normal, foldable position if the scissors assemblies are disposed in a flat or over-center position. To this end, an elastic or otherwise resilient mass 158 is mounted on the downward side of upper flange 92. The resilient mass 158 could be rubber or a synthetic resilient and elastic material that returns to its original natural shape after a compressive force is withdrawn. In the illustrated embodiment of FIGS. 14-16, the upper flange 92 includes an aperture 160 through which a portion 162 of mass 158 extends to hold mass 158 in place beneath upper flange 92. The underside 164 of mass 158 is adapted to engage the upper connection between corresponding double linkage assemblies 74 and single linkage members 76, as seen in FIG. 15.

FIG. 15 shows the resilient mass 158 under compression when ramp assembly 10 is in an expanded position. As ramp assembly 10 is moved to its contracted position, mass 158 exerts a force between upper flange 92 and linkages 74, 76, driving sliding mounting bracket 84 in an upward direction. This upward motion will prevent linkage assemblies 108 from going into an over-center or flat configuration, or will assist in withdrawing linkage assemblies 108 from a flat or over-center configuration should such occur.

The inventor has determined that when initiating movement of the ramp assembly 10 from its fully expanded position (FIG. 1) to its contracted position (FIGS. 2, 4, 5), the application of a lateral or horizontal force through handles 67 may not always be sufficient to start collapsing the scissors assemblies 12, 14 due to the alignment of certain of the links making up the scissors assemblies 12, 14 and the tread support assembly 16. To resolve this problem, finger or hand grippable hooks 182 (FIGS. 1, 2) are attached to the top of outermost sliding mounting bracket assembly 84 on each of scissors assemblies 12, 14. Hooks 182 are each adapted to be grasped by the fingers or hands of a user to apply a short vertical lift to the scissors mechanisms 12, 14 to initiate motion of the ramp assembly 10 to its contracted position. Once the contraction motion has been started, the user grasps the handles 67 and applies a continuous lateral or horizontal motion to the ramp assembly 10 until the ramp assembly reaches the collapsed position shown in FIGS. 4 and 5. By continuing to apply a manual force to handles 67, ramp assembly 10 is rotated about pins 32 to the position shown in FIG. 5, where contracted ramp assembly 10 rests in a vertical array on slanting tread plate 62 and upper mounting plate 48. Strap or belt 168 (FIG. 11) is then extended around ramp assembly 10 and fastened to the bottom of upper mounting plate 48 to hold ramp assembly 10 in its collapsed position as the vehicle is moving and jostled during transport.

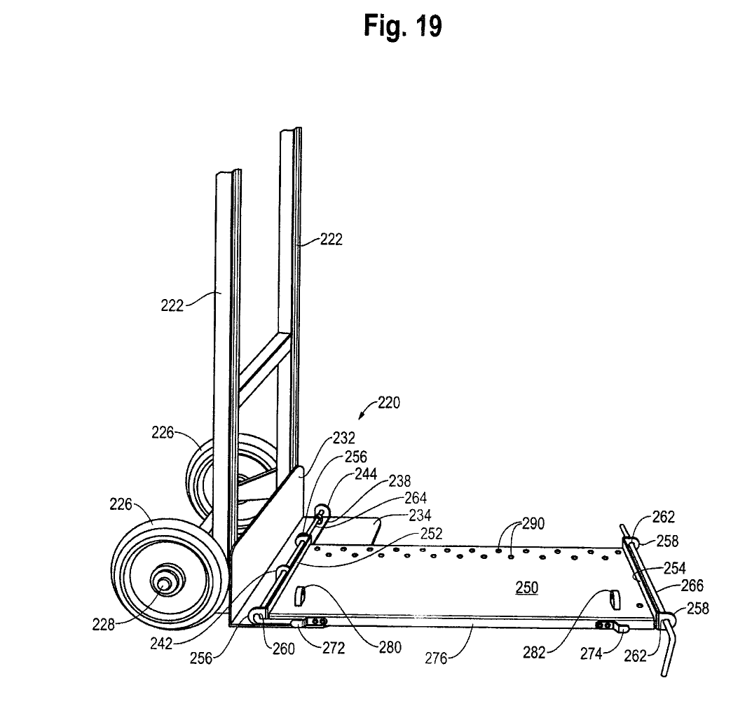

In operation, ramp assembly 10 may be stored in the garage, basement, storage room, shed or other location on or near the premises of the handicapped person. Alternatively, ramp assembly 10 may be mounted on hand cart 220 (FIGS. 19-21), as will be explained, and the combined hand cart 220 and ramp assembly 10 may be appropriately stored. When it is desired to move the wheelchair bound handicapped person into a vehicle for transport, the ramp assembly 10 is either carried out to the side door of the vehicle, where the vehicle is a van, or the ramp assembly 10 is wheeled to the vehicle side door region on hand cart 220, and then the ramp assembly is separated from the hand cart and the hand cart is either placed in the vehicle or returned to storage.

To mount ramp assembly 10 to the vehicle to allow the wheelchair bound person to advance up the ramp assembly and into the vehicle, the ramp assembly 10 in its collapsed folded position (FIGS. 5, 6) is rotatably attached to upper mounting plate 48 (FIG. 4) by aligning apertures 30 (FIG. 13) located at the lower ends of end links 26, 28 with corresponding apertures (not shown) in flanges 56, 58 of upper mounting plate 48. Releasable locking pins 32 (FIGS. 4, 5, 12) are inserted through the two sets of aligned apertures, thereby pivotally attaching ramp assembly 10 to upper mounting plate 48. As previously described, upper mounting plate 48 is pivotally attached to lower mounting plate 34, with lower mounting plate 34 secured to the vehicle platform or floor 20 (FIG. 1).

Next, the strap 168 (FIG. 11) is removed from around folded ramp assembly 10, and the user or operator grasps handles 67 (FIG. 2, 4) and unfolds ramp assembly 10 to its expanded position (FIGS. 1, 2). The leg assemblies 144 on both sides of ramp assembly 10 are pivoted outward (FIG. 8) and vertically adjusted, if necessary, to support the middle portion of scissors assemblies 12, 14 and tread support assembly 16. The end of the ramp assembly 10 located away from the vehicle is placed on the ground.

The wheelchair bearing the handicapped person is either advanced up the ramp assembly 10 by an aide, or the handicapped person manipulates the wheels of the chair to move him/herself up the ramp and into the vehicle. Alternatively, the ramp assembly 10, scissors assemblies 12, 14 and tread assembly 16, as previously described, have sufficient strength to support a motorized wheelchair advancing in either direction along ramp assembly 10. The wheelchair, once in the vehicle, is strapped or otherwise secured to the floor of the vehicle to prevent movement of the wheelchair during movement of the vehicle.

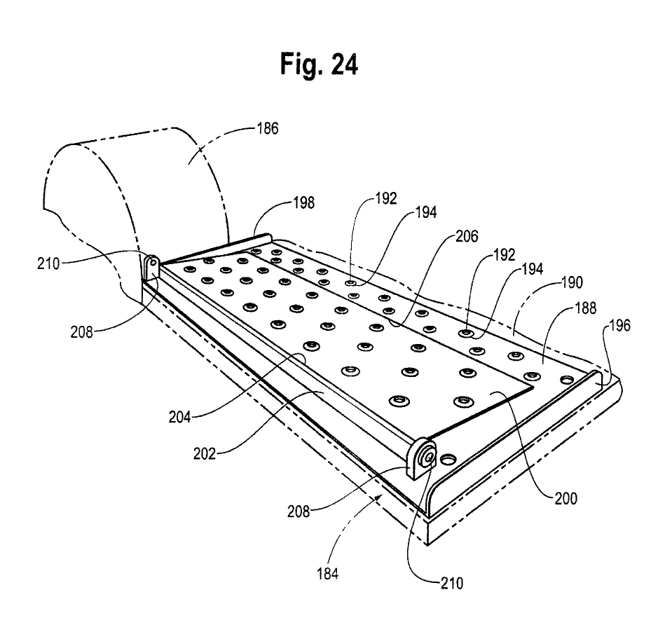

A further embodiment of the present invention provides handicap access to smaller automotive vans and vehicles currently being sold, known as “mini-vans.” In these vehicles, referring to FIG. 24, the side sliding access door opens a portal 184 to the inside of the vehicle, with the rearward jamb of the portal 184 located close to or adjacent the rear wheelwell 186, where the wheelwell extends into the passenger compartment of the van. In this embodiment, a flat lower plate 188 is securely fastened to the floor 190 of the van. Apertures 192 having raised rims 194 are disposed in lower plate 188 to provide light weight, strength and a gripping surface to plate 188. Flanges 196, 198 extend upward along the side edges of plate 188. An upper slanted plate 200 is securely mounted to lower plate 188, whereby slanted plate 200 includes a vertical flange 202 on one lateral side to elevate the forward end 204 of plate 200 above the plane of plate 188. The rearward end 206 of upper plate 200 rests on plate 188, providing the slant for upper plate 200. Plate 200 is provided with a slant because when ramp assembly 10 is attached to lower plate 188, the tread 60 (FIG. 1) closest to flat lower plate 188 is at an elevation slightly higher than the plane of lower plate 188. Slanted plate 200 allows a handicapped person in a wheelchair to smoothly traverse the end of ramp assembly 10, across slanting plate 200 and flat plate 188 and onto the floor 190 of the vehicle. Once the handicapped person and the wheelchair are in the van, the wheelchair is secured against movement during transport by any suitable means as are known in the art.

A pair of attachment blocks 208 are secured to opposite ends of lower plate 188, and are spaced apart a distance substantially equal to the distance between end single link 26 of scissors assembly 12, and end single link 28 of scissors assembly 14 (FIG. 2). This distance between attachment blocks 208 approximates the width of ramp assembly 10. It is contemplated that the width of ramp assembly 10 may vary according to the width of portal 184 (FIG. 24), whereby the width of ramp assembly 10 may vary to accommodate handicap access to vehicles and other transport devices having entrance ways of varying widths.

Each attachment block is made of sturdy material, such as aluminum, iron, steel or the like, and includes an aperture 210 extending through the width of the block. Referring to FIGS. 4, 13 and 24, each aperture 210 is adapted to receive a releasable mounting pin 32 after the apertures (not shown) at the outer ends of end single links 26 and 28 of ramp assembly 10 are aligned with apertures 210 in attachment blocks 208. Releasable mounting pins 32 removably and pivotally mount ramp assembly 10 to lower plate 188 in the same manner as described in connection with the embodiment of FIGS. 1-13. When not in use, ramp assembly 10 is removed from lower plate 188, and lower plate 188 and upper slanted plate 200 remain secured to the floor 190 of the transport vehicle, such as a mini-van. The relatively low profile of plates 188 and 200 do not interfere with normal access to and egress from the vehicle.

A further unique feature of the present invention is the provision of a movable modified truck assembly to which the ramp assembly 10 can be removably attached when the ramp assembly is removed from the vehicle after the handicapped person has used the ramp assembly to egress the vehicle. In addition, the truck assembly can be used to store the ramp assembly in a garage, basement or the like when not in use.

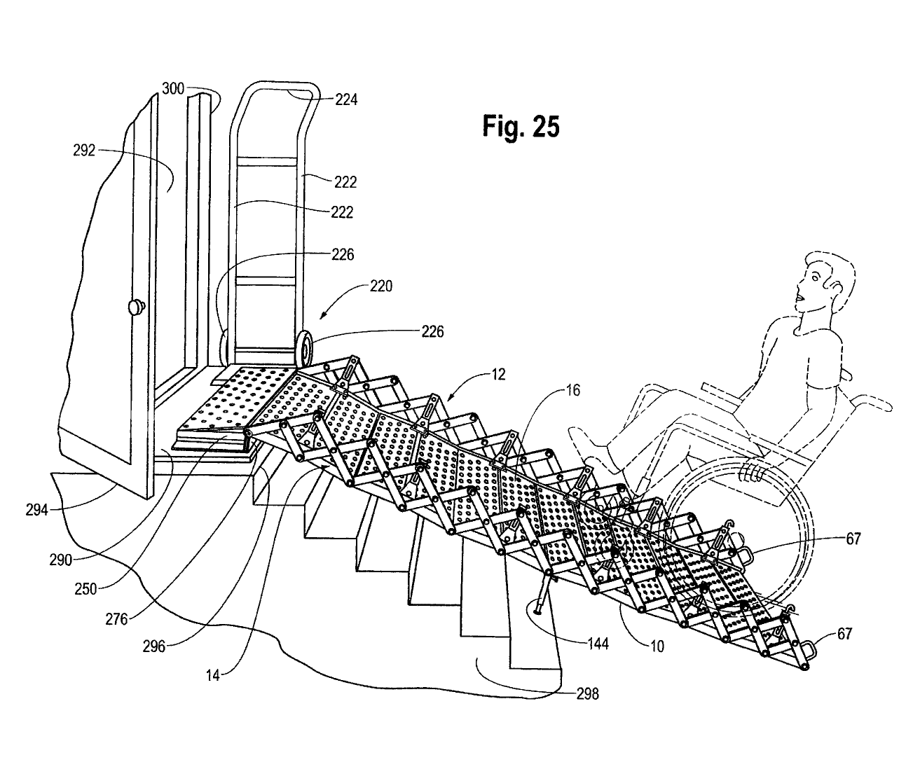

The unique movable modified truck assembly is illustrated by the hand cart assembly generally designated by the numeral 220 in FIGS. 19-23 and 25. Referring to FIG. 19, the hand cart 220 includes a pair of parallel struts 222 extending upward and connected to a manually grippable handle or crosspiece 224 (FIG. 25). The hand cart 220 also includes a pair of wheels 226 rotatably mounted on axle 228, with the axle 228 secured to the hand cart 220 as is known in the art.

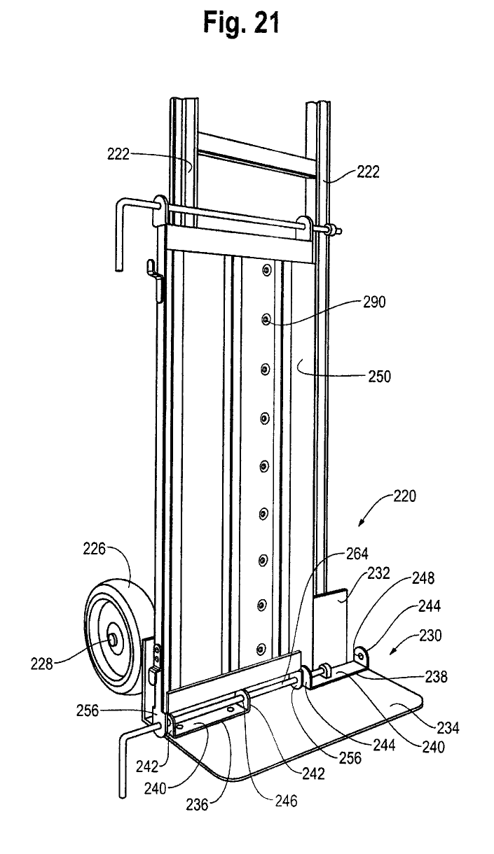

At the lower end of struts 222 a support plate 230 is mounted to hand cart 220, the support plate 230 having a vertically extending portion 232 and a horizontally extending portion 234. As best seen in FIGS. 19 and 21, a pair of similarly constructed brackets 236, 238 are securely fastened at their respective bases 240 to horizontal portion 234 of hand cart 220. As seen in FIG. 21, the bracket 236 has a pair of upstanding flanges 242 at opposite ends, and the bracket 238 has a pair of upstanding flanges 244 at opposite ends. Each flange 242, 244 includes an aperture 246, 248 respectively extending through the respective flange. Brackets 236, 238 are mounted on horizontal plate portion 234 such that all apertures 246, 248 are in linear alignment for purposes to be explained.

A support plate 250 is adapted to be pivotally and removably attached to hand cart 220. As best seen in FIGS. 19, 20 and 23, support plate 250 includes a first bracket 252 at one side end of the support plate, and a second bracket 254 at an opposite end of support plate 250. Each bracket 252, 254 has a pair of laterally extending flanges 256, 258, respectively, and each flange 256, 258 includes an aperture 260, 262, respectively, extending therethrough. Apertures 260 are in axial alignment, and apertures 262 are in axial alignment. A removable connecting rod 264 extends through apertures 260, and a removable connecting rod 266 extends through apertures 262 (FIG. 19). An angled portion 268, 270 is attached or formed at one end of each connecting rod 264, 266 providing a handle for manual manipulation of rods 264, 266 through respective apertures 246, 260 and 248, 262, as will be explained.

A pair of angle brackets 272, 274 are mounted on side panel 276 of support plate 50, as seen in FIGS. 19, 20 and 22. Referring to FIG. 22, a space 278 is formed between a portion of each bracket 272, 274, which space is adapted to receive the angled portion 268, 270 of the respective connecting rod 264, 266 and hold the angled portions in place and against undesired movement.

Referring to FIGS. 19, 20, 22 and 23, opposed mounting blocks 280, 282 are secured to the upper surface of support plate 250. Each mounting block has an aperture 284 extending therethrough. The distance between the outer surfaces of mounting blocks 280, 282 are the same as, or slightly less than, the distance between end single link 26 and end single link 28 of ramp assembly 10 (FIG. 1). The apertures 284 are adapted to receive releasable mounting pins (not shown) to removably and pivotally attach ramp assembly 10 to support plate 250.

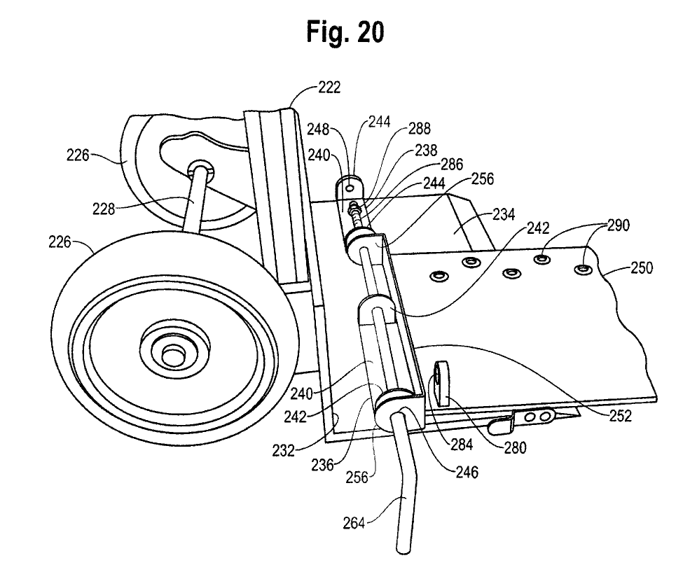

Referring to FIGS. 19 and 20, support plate 250 is pivotally attached to hand cart 220 by first aligning apertures 260 and 262 in bracket 252 with apertures 246 and 248 in bracket 238. Connecting rod 264 is then inserted through all the aligned apertures, with one flange 256 of bracket 252 located adjacent flange 242 of bracket 236, and second flange 256 located at a distance from flange 242 of bracket 236. As seen in FIG. 20, connecting rod 264 includes a threaded surface 286 and a bolt 288 engaging the threads to prevent connecting rod 264 from becoming disengaged from flanges 242 and 256. When it is desired to remove or install support plate 250 from or on hand cart 220, bolt 288 is disengaged from connecting rod 264, and the connecting rod is withdrawn from the apertures in flanges 242 and 256.

Referring to FIG. 21, when hand cart 220 is not in use, support plate 250 is pivoted about connecting rod 264 to a vertical position adjacent struts 222. Additionally, support plate 250 includes a plurality of raised rim apertures 290 to provide a non-slip tread surface for plate 250, reduce the weight of the support plate, and add strength to the support plate.

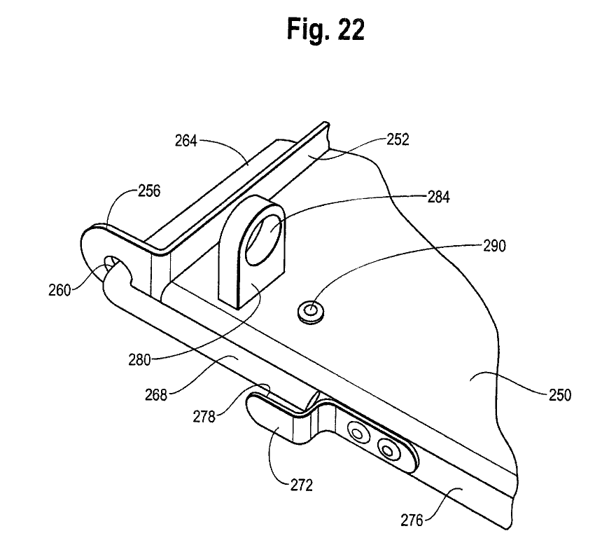

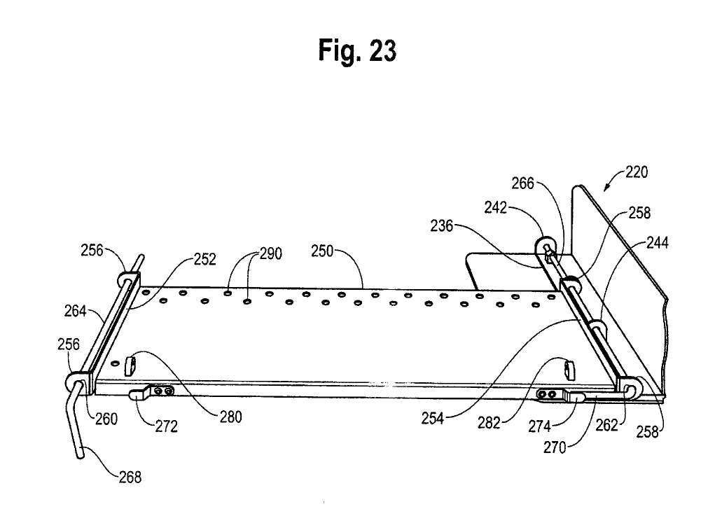

The brackets 236 and 238 (FIG. 20) are dimensioned and located on the horizontal portion 234 of support plate 230, such that either end of support plate 250 can be pivotally mounted on horizontal portion 234. This allows the hand cart 220, with ramp assembly 10 attached, to provide handicap access across a set of stairs and into a doorway regardless of which side of the door jamb the door itself is mounted. This alternate mounting position of support plate 250 to brackets 236, 238 of hand truck 220 is shown in FIG. 23. In this configuration, connecting rod 266 extends through apertures 262 in flanges 258 (FIGS. 19, 23) of support plate 250, and through the apertures in upstanding flanges 244 in bracket 238. The rod 266 also extends through one or both apertures in upstanding flanges 242 of bracket 236, as seen in FIG. 23. As seen in FIG. 23, the support plate 250 is mounted on the opposite side of hand cart 220 compared to the position of support plate 250 shown in FIG. 19.

Referring to FIG. 25, ramp assembly 10 is pivotally mounted on mounting blocks 280, 282 (FIG. 23) of support plate 250. Support plate 250 is mounted to a truck device, such as hand cart 220 as seen in FIG. 23, and hand cart 220 is positioned on an elevated surface 290, such as a porch, in front of an entrance doorway 292 having a door 294, all of which are part of a building or facility structure 300. The hand cart 220 is positioned on the side of doorway 292 away from the door, and the front side panel 276 of support plate 250 is located adjacent the front extent 296 of porch 290. Ramp assembly 10, having previously been moved to its collapsed or contracted position (as seen in FIG. 5) on support plate 250, is expanded over a flight of steps or stairs 298 as shown in FIG. 25. The end of ramp assembly 10 away from hand cart 220 is placed on the ground, and feet 144 are appropriately extended downward to contact either one of the steps of stairs 298, as shown in FIG. 25, or to contact the ground, depending on the slope of stairs 298, as is understood by one of skill in the art. It is also understood that hand cart 220 may be manually or otherwise held in place on the surface of porch 290 to restrain hand cart 220 from movement in either a lateral or linear direction relative to wheels 226. With hand cart 220 located and held in place as shown in FIG. 25, and ramp assembly 10 in its expanded position as illustrated, a handicapped person in a wheelchair, and an aide if necessary, may advance the wheelchair and the handicapped person up or down the ramp assembly 10, either into or out of the building structure 300.

After the handicapped person has been advanced up the ramp assembly 10 and into the building structure 300, the ramp assembly may be moved to its collapsed or contracted position as illustrated in FIGS. 2, 4 and 5. While in the contracted position (FIG. 5) and still mounted on support plate 250 and hand cart 220, the hand cart 220 may be moved to a second out-of-the-way location on porch 290 until needed again. When the handicapped person is ready to leave building structure 300, the hand truck 220 and collapsed ramp assembly 10 seated on support plate 250 are moved back into position near the front extent 296 of porch 290, and ramp assembly 10 is extended from porch 290, over stairs 298 and onto the ground in front of the stairs 298. The handicapped person in the wheelchair is then moved across tread support assembly 16 to the ground.

After reaching the ground, the ramp assembly 10 is moved to its contracted position as shown in FIG. 5, and the folded ramp assembly 10 is placed on top of support plate 250. The releasable pins (not shown) extending through apertures 284 in mounting blocks 280, 282 (FIG. 22, 23) are removed, thus releasing ramp assembly 10 from support plate 250 and hand cart 220. The ramp assembly is next moved to mounting assembly 18 on vehicle entrance platform 20 (FIG. 1, 2) and end single links 26, 28 are positioned adjacent mounting assembly 18 whereby the apertures (not shown) adjacent the outer ends of end single links 26, 28 are aligned with corresponding apertures in flanges 56, 58 of upper mounting plate 48 (FIGS. 4, 5) Releasable mounting pin 32 is inserted in each corresponding set of apertures, rotatably connecting ramp assembly 10 to upper mounting plate 48 disposed over lower mounting plate 34 on the platform or floor 20 of the vehicle. The ramp assembly is then extended to its position shown in FIG. 1, and the handicapped person in the wheelchair is moved up tread support assembly 16 and secured in the vehicle. Ramp assembly 10 is then moved to its contracted position (FIGS. 2, 4 and 5), and in the embodiment shown in FIG. 11, is rotated ninety degrees to the position shown in FIG. 11. The vehicle then transports the handicapped person to his/her next destination, where the ramp assembly 10 is deployed as previously described to allow the handicapped person to disembark from the vehicle.

In an embodiment of the invention, collapsed ramp assembly 10 may be pivoted out of the way of additional passengers entering the vehicle through the sliding side door. As previously described, and as shown in FIGS. 5 and 6, ramp assembly 10 in its contracted or folded position, is seated on upper mounting plate 48. Release pin 70 is removed from apertures 68, 69 (FIGS. 5, 6, 17) thereby releasing upper mounting plate 48 for pivotal movement relative to lower mounting plate 34. As previously described, upper mounting plate 48 is pivotally connected to lower mounting plate 34 by means of bolts 52 (FIG. 4). The user grasps handle 66 (FIGS. 4, 5, 17) and rotates upper mounting plate 48 ninety degrees until the upper mounting plate and folded ramp assembly 10 are in the position shown in FIG. 11 and out of the path of the side entry doorway of the vehicle. Additionally, the hand cart 220 (FIG. 19) should be placed in the vehicle for use at the destination of the vehicle to allow the handicapped person to leave the vehicle, and to provide handicap access across a set of stairs, as was explained in association with the embodiment of the invention shown in FIG. 25.

After the ramp assembly 10 has been rotated to the position shown in FIG. 11, the vehicle transports the handicapped person in the wheelchair to the desired destination. To enable the wheelchair and handicapped person to disembark the vehicle through the sliding side door, once the vehicle is stopped and the door moved to its open position, ramp assembly 10 is rotated about bolts 52 from the position shown in FIG. 11 to the position supported by lower mounting plate 34 shown in FIGS. 5, 6. Release pin 70 is re-inserted through aperture 68 in flange 50 of the lower mounting plate 34 and through aperture 69 (FIGS. 17, 18) of flange 58 of upper mounting plate 48, thus securing the upper mounting plate against rotation on the lower mounting plate 34. Since lower mounting plate 34 is fastened to the floor 36 of the vehicle, upper mounting plate 48 is also effectively secured against movement in the vehicle.

The user removes strap 168 from ramp assembly 10, grasps handles 67 in both hands (FIG. 2), and walks rearwardly extending ramp assembly 10 to its full expanded position as shown in FIG. 1. Leg assemblies 144 are deployed to their vertical position and adjusted as appropriate to locate tread support assembly 16 in a proper position when the outer end of ramp assembly 10 is placed on the ground or other surface. After the ramp assembly 10 is properly extended and supported as shown in FIG. 1, the wheelchair is released from its straps or other restricting device in the vehicle, and the wheelchair bearing the handicapped person is wheeled first up slanted tread plate 62 (FIGS. 1, 2) and onto tread support assembly 16 of ramp assembly 10. The wheelchair advances down tread support assembly 16 until it reaches the ground or other support surface upon which the outer end of ramp assembly 10 is placed.

After the wheelchair moves off of the ramp assembly 10, the user pivots leg assemblies 144 back to their storage position (FIGS. 6, 7), and grasps hooks 182 providing a slight vertical force on the outer end of ramp assembly 10, as previously described, to initiate movement of ramp assembly 10 and scissors assemblies 12, 14 to their folded positions and to overcome any possible over-center or flat positions of the scissors assemblies 12, 14 and/or tread support assembly 16. Then, the user grasps handles 67, one in each hand, lifts the outer end of ramp assembly 10 off the ground, and walks toward the vehicle (FIG. 2), causing ramp assembly 10 to resume its folded or contracted position shown in FIGS. 5, 6.

It may be necessary to use the ramp assembly 10 to provide handicap access up or down a set of stairs, or the like, at the destination. In this situation, the modified hand cart 220 (FIGS. 19, 21) is removed from the vehicle, and ramp assembly 10 is pivotally attached to the hand cart 220 as described in association with the embodiment shown in FIGS. 19-23 and 25. In particular, the ramp assembly 10, when mounted on hand cart 220 may be deployed as shown in FIG. 25 to provide handicap access up or down a set of stairs.

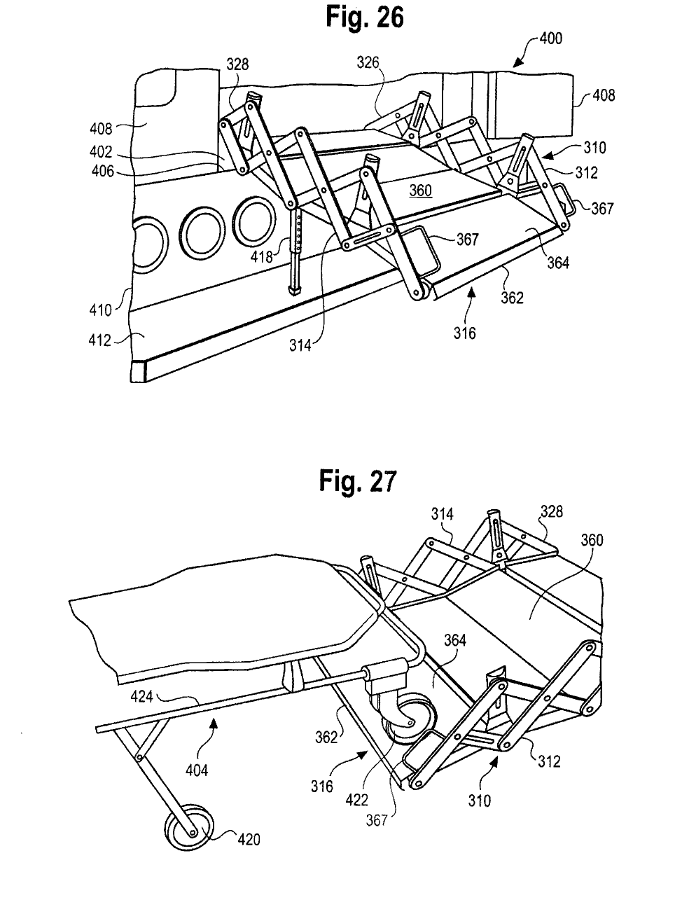

A further embodiment of the present invention is illustrated in FIGS. 26-29. This embodiment is directed towards a ramp for providing an emergency medical technician (EMT) with an easier and safer method of moving a stretcher up and into an ambulance. Due to a combination of ambulance floor height and stretcher design, the EMT may be required to lift the patient-bearing stretcher up and then into the ambulance, resulting in possible work related injuries. In cases where the patient is obese, it may take several EMT's to lift the stretcher up to a plane level with the floor of the ambulance. If there are not enough EMT's available to lift the heavy-laden stretcher, either the patient will not be placed in the ambulance, or one EMT may sustain injuries attempting to carry out his or her mission.

The embodiment of the present invention shown in FIGS. 26-29 is adapted to be mounted in an ambulance generally designated by the numeral 400, having a deck or floor 402 on which a stretcher 404 (FIG. 27), bearing a patient, is removably supported. The deck 402 has a rear portion 406 that extends between the side walls of ambulance 400. A pair of doors 408 swing open and shut to provide access to and egress from the deck 402 of ambulance 400.

The ramp assembly 310 shown in FIGS. 26-29, which is similar in structure but shorter in scissors elements and expanded length than the embodiment of the present invention shown in FIGS. 1-18, comprises parallel and opposed scissors assemblies 312, 314, with tread support assembly 316 extending between each scissors assembly. Each scissors assembly 312, 314 has a single link 326, 328 at one end, with apertures (not shown) located adjacent the outer end of each link 326, 328.

In the illustrated embodiment of FIGS. 26-29, lower mounting plate 334 is secured to rear portion 406 of ambulance deck 402, a short distance from the rear end of deck 402. A pair of flanges 340, 342 extend upward from lower mounting plate 334, having apertures (not shown).

An upper mounting plate 348 is pivotally attached to lower mounting plate 334 on flanges 340, 342 in the same manner shown in attaching lower mounting plate 34 to upper mounting plate 48 in FIG. 11. Also, the single links 326, 328 at the end of scissors assemblies 312, 314 are pivotally connected to upper mounting plate 348 in the same manner shown in attaching scissors assembly end link 28 to upper mounting plate 48.

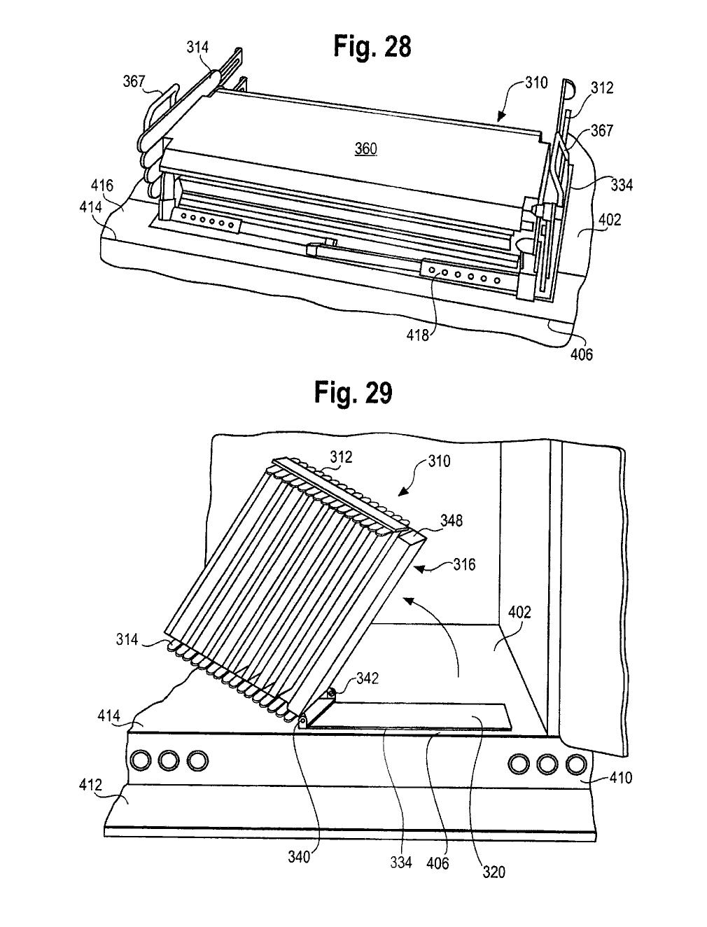

Ambulance 400 includes an L-shaped rear bumper 410 having a step 412 extending horizontally from the ambulance 400. The upper edge 414 (FIG. 28) of bumper 410 is substantially flush with ambulance deck 402. As seen in FIG. 28, lower mounting plate 334 is secured to deck 402 from one to eight inches from upper edge 414, and sits atop deck sill 416.

In operation, ramp assembly 310 may be in the position shown in FIG. 28 when the ambulance arrives at the scene of a medical incident with a patient on a stretcher who must be transported to a medical treatment facility. Upper mounting plate 348 is locked in position adjacent lower mounting plate 334 in the same manner that locking pin 70 holds the two mounting plates together as shown in FIG. 5 or 18. A strap similar to the strap 168 shown in FIG. 11 may extend around tread support assembly 316 to hold the ramp assembly 310 in the contracted position (FIG. 28). To expand the ramp assembly from the contracted position shown in FIG. 28, strap 168 is removed, the EMT grasps handles 367 and pulls ramp assembly 310 outward to the position shown in FIGS. 26 and 27. The tread support assembly 316 moves treads 360 into a substantially flat and aligned position, providing a platform extending outward to the edge 362 of outermost tread plate 364.

Pivotally attached to each scissors mechanism 312, 314 is an adjustable self centering leg assembly 418 that is mounted for movement between a storage position (FIG. 28) and a support position (FIG. 26) in the same manner that leg assembly 144 is pivotally attached to each scissors assembly 12, 14 in the embodiment shown in 1, 2 and 6-8. As seen in FIG. 26, leg assemblies 418 are extended, after extending ramp assembly 310, to a length whereby the bottom of each leg assembly rests on step 412 of ambulance rear bumper 410, and ramp assembly 310 is held in a downward angle such that edge 362 of outermost tread plate 364 is vertically positioned below rear portion 406 of deck 402. As described previously with regard to leg assemblies 144 (FIG. 7), the length of leg assemblies 418 are linearly adjustable such that the angle of slant of treads 360, and the vertical position of tread plate edge 362 may be varied as desired for the particular need upon the expansion of ramp assembly 310.

Once ramp assembly 310 is expanded as described, and leg assemblies 418 are placed to support ramp assembly 310 above horizontal step 412, stretcher 404 in the illustrated embodiment of FIG. 27, bearing a patient to be transported to or from a medical treatment facility, is moved on forward and rear collapsible lower wheels 420 to a position whereby upper stretcher wheels 422 come into contact with outermost tread plate 364 of ramp assembly 310. As seen in FIG. 27, lower stretcher wheels 420 are still on the ground, and upper stretcher wheels 422 are below the level of ambulance deck 402.

The EMT then asserts a force on stretcher 404, moving the stretcher, with patient aboard, toward deck 402. Upper stretcher wheels 422 begin to ride up on treads 360 of ramp assembly 310, lifting the front end of the stretcher as the stretcher 404 moves forward. At this point, forward lower stretcher wheels 420 may be folded upward toward the stretcher frame 424, and the EMT continues to move the stretcher toward the deck 402 while simultaneously holding the rear end of the stretcher in a horizontal position. If the rear lower stretcher wheels 420 work independently of the forward wheels 420, the rear wheels 420 may remain extended after the front wheels 420 are folded, thereby assisting in supporting the stretcher 404 and the patient on the stretcher as the stretcher is moved along ramp assembly 310 and into the ambulance 400. The EMT continues to move the stretcher 404 toward and onto the ambulance deck 402 until front upper stretcher wheels 422 pass over ramp assembly 310 and roll along deck 402 of the ambulance. If not done previously, rear lower stretcher legs 420 are folded, and a pair of rear upper stretcher wheels (not shown) ultimately engage ramp assembly 310 and the stretcher is moved onto the deck 402 of ambulance 400 and locked in place as is known in the art. It is apparent that while moving the stretcher 404 into ambulance 400 using ramp assembly 310 as described above, the EMT did little or no vertical lifting.

After stretcher 404 is locked in place in ambulance 400, handles 367 (FIGS. 26, 27) are grasped by the EMT, who then moves forward holding the handles, and folds ramp assembly 310 into its folded or contracted position on top of upper mounting plate 348, as seen in FIG. 28. The strap 168 (FIG. 11) is secured around contracted ramp assembly 310 to prevent movement of the ramp assembly out of its contracted position as the ambulance 400 is driven to its destination.

In the embodiment of FIG. 29, the ramp assembly may be pivoted out of the way of one side of the entrance platform 320 of the ambulance for a specific application. As seen in FIGS. 11 and 29, the scissors assemblies 312, 314 and tread support assembly 316 are pivotally mounted to upper mounting plate 348. There is also a pivotal mounting assembly formed by flanges 340, 342 between one end of upper mounting plate 348 and lower mounting plate 334, similar to the pivotal mounting assembly between mounting plates 34 and 48 in FIGS. 11 and 12. The mounting plates 334, 348 are maintained together in a locked position by removable locking pin 70 (FIGS. 11, 18). With ramp assembly 310 in its contracted position (FIGS. 28, 29), locking pin 70 is withdrawn from aligned apertures extending through parallel flanges on upper mounting plate 348 and lower mounting plate 334, thereby releasing upper mounting plate 348 for lateral ninety degree pivotal movement relative to the linear direction of expansion and contraction of ramp assembly 310. As seen in FIG. 29, ramp assembly 310, with upper mounting plate 348, can be rotated ninety degrees upward and out of the direct path of the stretcher. When needed again, the folded ramp assembly 310 is pivoted back to the position shown in FIG. 28, and locking pin 70 is re-inserted into the aligned apertures in the parallel flanges on upper mounting plate 348 and lower mounting plate 334, the strap 168 (FIG. 11) is removed, and the ramp assembly 310 is ready to be expanded to assist in moving stretcher 404 into or out of ambulance 400 as described above.

The foregoing description of a preferred embodiment of the invention has been presented for purposes of illustration and description, and is not intended to be exhaustive or to limit the invention to the precise form disclosed. The description was selected to best explain the principles of the invention and practical application of these principals to enable others skilled in the art to best utilize the invention in various embodiments and various modifications as are suited to the particular use contemplated. It is intended that the scope of the invention not be limited by the specification, but be defined by the claims set forth below.

I claim:

1. An expandable and contractable ramp assembly for moving handicapped persons between a first elevation and a structure at a second elevation, said ramp assembly comprising:
a. an attachment assembly adapted to removably secure a first end of the ramp assembly to said structure at said second elevation;
b. said ramp assembly being expandable and contractable in a linear direction;
c. said attachment assembly providing pivotal movement of said ramp assembly in an arcuate direction perpendicular to said linear direction;
d. said ramp assembly comprising a pair of parallel disposed scissors assemblies, said scissors assemblies moveable between said expanded and contracted positions;
e. a tread support assembly extending between and operatively connected to said pair of parallel scissors assemblies;
f. said tread support assembly including a plurality of tread plates, each tread plate connected to a tread plate support structure, said support structure supporting said tread plates.

2. The expandable and contractible ramp assembly of claim 1 wherein said scissors assembly and said tread support assembly are adapted to be supported by said structure when said scissors assembly is in said contracted position.

3. The expandable and contractable ramp assembly of claim 1, wherein a second end of the expanded ramp assembly is adapted to be located at said first elevation when said first end is removably secured to said structure.

4. The expandable and contractable ramp assembly of claim 1, comprising:
adjustable leg assemblies pivotally mounted on each of said scissors assemblies, said leg assemblies moveable from a first inoperative position to a second operative position.

5. The expandable and contractable ramp assembly of claim 4,
wherein said leg assemblies are adjustable in length and are adapted to extend from each of said scissors assemblies to said first elevation and to support each scissors assembly when said ramp assembly is in said expanded position.

6. The expandable and contractable ramp assembly of claim 1, wherein said attachment assembly comprises a mounting plate assembly having a first plate adapted to be secured to said structure, and a second plate pivotally mounted to said first plate.

7. The expandable and contractable ramp assembly of claim 6 wherein said scissors assemblies are pivotally mounted to said second plate.

8. The expandable and contractable ramp assembly of claim 7 wherein said first plate and said second plate are selectively locked against movement relative to one another, and are selectively unlocked to allow said relative movement between said first and second plates.

9. The expandable and contractable ramp assembly of claim 8 wherein said second plate is seated upon said first plate when said first and second plates are locked together.

10. The expandable and contractable ramp assembly of claim 1 wherein said tread plate support structure comprises:
a plurality of tubular support members extending between parallel disposed links, said links pivotally mounted for movement with opposed scissors assemblies.

11. The expandable and contractable ramp assembly of claim 6 wherein:
said scissors assemblies are removably and pivotally mounted to said second plate.

12. The expandable and contractable ramp assembly of claim 6 wherein an additional tread plate is angularly mounted on one side of said second plate, said additional tread plate adapted to extend between said plurality of tread plates and said structure.

13. The expandable and contractable ramp assembly of claim 1 wherein each said scissors assembly comprises a plurality of scissors links pivotally connected in a lazy tong scissors array; and a plurality of additional links moving vertically with respect to said plurality of links; and a compression cushion disposed between said additional links and certain of said scissors links, said compression cushion preventing said scissors assemblies and said tread support assembly from moving to an over center position when the ramp assembly is in its expanded position.

14. The expandable and contractable ramp assembly of claim 1 further comprising:
a movable cart assembly including a support plate, said support plate including a first pair of mounting brackets;
said first pair of mounting brackets adapted to removably attach said ramp assembly to said cart assembly;
said ramp assembly movable between said contracted position on said support plate to said expanded position with said tread plates extending outward from said support plate of said cart assembly in said expanded position.

15. The expandable and contractable ramp assembly of claim 14, wherein:
said support plate is pivotally mounted to said cart assembly.

16. The expandable and contractable ramp assembly of claim 14, wherein:
said first pair of mounting brackets are adapted to removably and pivotally attach said ramp assembly to said cart assembly.

17. The expandable and contractable ramp assembly of claim 14, wherein:
said cart assembly comprises a first pair of U-shaped brackets with opposed, aligned apertures, said U-shaped brackets mounted on said cart assembly;
said support plate includes a second pair of U-shaped brackets having opposed, aligned apertures, each of said pair of second U-shaped brackets mounted at opposed ends of said support plate;
a pair of connecting rods, one of each said pair of connecting rods removably extending through said opposed aligned apertures in each said second U-shaped bracket mounted on said support plate;
one of said connecting rods additionally removably extending through certain of said opposed, aligned apertures in said first pair of U-shaped brackets mounted on said cart assembly when said support plate is pivotally attached to said cart assembly.

18. The expandable and contractable ramp assembly of claim 17, wherein either of said opposed ends of said support plate is selectively and removably attachable to said cart assembly.

19. The expandable and contractable ramp assembly of claim 14, wherein said support plate includes a plurality of raised rim apertures providing a non-slip tread surface for the support plate.

20. An expandable and contractable ramp assembly for moving handicapped persons between a first elevation and a structure at a second elevation, said ramp assembly comprising:
a. an attachment assembly adapted to removably secure a first end of the ramp assembly to said structure at said second elevation;
b. said ramp assembly comprising a pair of parallel disposed scissors assemblies, said scissors assemblies moveable between said expanded and contracted positions;
c. a tread support assembly extending between and operatively connected to said pair of parallel scissors assemblies;
d. said tread support assembly including a plurality of tread plates, each tread plate connected to a tread plate support structure, said tread plate support structure supporting said tread plates.
e. a lower plate firmly attached to said structure, said lower plate including opposed upstanding attachment blocks, said attachment blocks removably and pivotally mounting said pair of parallel disposed scissors assemblies to said lower plate.

21. The expandable and contractable ramp assembly of claim 20, further comprising an upper slanted plate attached to said lower plate, said upper slanted plate extending from a first plane at a height the same as the height of a tread plate closest to said structure when said parallel disposed scissors assemblies are mounted to said attachment blocks, to a second plane at a height of the lower plate.

22. The expandable and contractable ramp assembly of claim 1 wherein said scissors assembly and said tread support assembly are adapted to be supported by said structure when said scissors assembly is in said contracted position.

23. The expandable and contractable ramp assembly of claim 1, wherein a second end of the ramp assembly is adapted to be located at said first elevation when said first end is removably secured to said structure.

24. The expandable and contractable ramp assembly of claim 14 wherein:
said support plate is adapted to be located on a horizontal surface at said second elevation and adjacent an entrance to a facility, with stairs leading from said first elevation to said horizontal surface;
said tread plates adapted to extend over said stairs when said ramp assembly is expanded.

25. The expandable and contractable ramp assembly of claim 24, including at least one pivotal foot extending downward from said ramp assembly, said at least one pivotal foot assembly adapted to extend between said ramp assembly and said stairs when said foot assembly is pivoted to a position extending downward from said ramp assembly.

26. The expandable and contractable ramp assembly of claim 25, wherein said foot assembly has an adjustable length.

27. An expandable and contractable ramp assembly for loading and unloading a patient-bearing stretcher into an ambulance having a deck in the ambulance and a horizontal extending step below a rear portion of the ambulance deck, the stretcher having wheels disposed at a predetermined height on a portion of the stretcher, the ramp assembly comprising:
a. an attachment assembly adapted to removably secure a first end of the ramp assembly to said rear portion of said ambulance deck;
b. said ramp assembly being expandable and contractable in a linear direction and adapted to extend over said step when in said expanded position;
c. said ramp assembly comprising a pair of parallel disposed scissors assemblies, said scissors assemblies moveable between said expanded and contracted positions;
d. a tread support assembly extending between and operatively connected to said pair of parallel scissors assemblies, said tread support assembly comprising a tread support structure;
e. said tread support structure including a plurality of tread plates, each tread plate connected to said tread support structure;
f. at least one leg assembly attached to said ramp assembly, said leg assembly adapted to extend between said ramp assembly and said step when said ramp assembly is in said expanded position.

28. The expandable and contractable ramp assembly of claim 27:
said attachment assembly providing pivotal movement of said ramp assembly in an arcuate direction perpendicular to said linear direction.

29. The expandable and contractable ramp assembly of claim 27, wherein one of said tread plates is an outermost tread plate from said attachment assembly, said outermost tread plate adapted to be disposed below said predetermined height of said stretcher wheels when said ramp assembly is in said expanded position, said outermost tread plate adapted to receive said stretcher wheels when said stretcher is moved onto said ramp assembly.

30. The expandable and contractable ramp assembly of claim 27, wherein:
said at least one leg assembly is pivotally attached to said ramp assembly, said at least one leg assembly moveable to a folded position adjacent said tread support assembly when said ramp assembly is moved to said contracted position.

31. The expandable and contractable ramp assembly of claim 27 wherein said at least one leg assembly is adjustable in length.

32. The expandable and contractable ramp assembly of claim 1, wherein said tread plate support structure and said tread plates are made of aluminum.

33. The expandable and contractable ramp assembly of claim 1, wherein each of said scissors assemblies comprises a hand grippable member adapted to be grasped by a user for application of an upward force to initiate the contracting of the ramp assembly.
